(19) United States
(12) Patent Application Publication
(10) Pub. No.: US 2012/0041966 A1
(43) Pub. Date: Feb. 16, 2012

(54) DIRECTIONAL INFORMATION SEARCH FROM A MOBILE DEVICE

(75) Inventors: Masoud M. Kamali, San Francisco, CA (US); Anoosh Abdy, (US)

(73) Assignee: Virtual Beam, Inc., San Francisco, CA (US)

(21) Appl. No.: 13/184,417

(22) Filed: Jul. 15, 2011

Related U.S. Application Data
(60) Provisional application No. 61/364,744, filed on Jul. 15, 2010.
(60) Provisional application No. 61/415,013, filed on Nov. 18, 2010.
(60) Provisional application No. 61/441,218, filed on Feb. 9, 2011.

(51) Int. Cl. G06F 17/30

(52) U.S. Cl. 707/758; 707/E17.014

(57) ABSTRACT

The disclosed technique, apparatuses and devices enable a mobile device to act as a pointing device equipped with integrated search tools, to define a virtual beam within which to search and discover information associated therewith. The user of the mobile device does not have to type, speak or otherwise specify keywords as search criteria. The search criteria can be merely the virtual beam itself. Search results are generated at a remote server system and communicated back to the mobile device, and then presented to its user via graphical, audio and/or other format.

This application claims the benefit of: U.S. Provisional Patent application No. 61/364,744 filed on Jul. 15, 2010; U.S. Provisional Patent application No. 61/415,013 filed on Nov. 18, 2010; and U.S. Provisional Patent application No. 61/441,218 filed on Feb. 9, 2011; each of which is incorporated herein by reference.

### COPYRIGHT NOTICE

A portion of the disclosure of this patent document contains material which is subject to copyright protection. The copyright owner has no objection to the facsimile reproduction by anyone of the patent document or the patent disclosure, as it appears in the Patent and Trademark Office patent file or records, but otherwise reserves all copyright rights whatsoever.

### FIELD OF THE INVENTION

At least one embodiment of the present invention pertains to mobile search technology, and more particularly, to a method and apparatus for initiating from a mobile device, and performing a directed search along the trajectory.

### BACKGROUND

“Mobile search” is a process of accessing or retrieving information from or for a mobile device, such as a cellular telephone (e.g., a “smartphone”), personal digital assistant (PDA), tablet or notebook computer, or the like. The mobile search experience today consumes too much time, is error prone, inefficient, and impractical for humans. In many countries, for example, text messaging and/or voice calling are prohibited and illegal while driving a car. With voice activation and voice recognition, the problem is resolved partially (i.e., there is no need to enter search terms via a keyboard; instead, the user can simply speak keywords out loud into a microphone). However, problems exist even with this model in many situations. Spoken words can be transformed into text (e.g., search keywords) and then sent to a search engine at a backend server. In many cases, however, the user may not know what the best keywords or search criteria are.

### SUMMARY

This summary is provided to introduce in a simplified form certain concepts that are further described in the Detailed Description below and the drawings. This summary is not intended to identify essential features of the claimed subject matter or to limit the scope of the claimed subject matter.

The technique disclosed herein enables a mobile device to act as a pointing device equipped with integrated search tools, to produce a virtual trajectory, or “virtual beam,” within which to search and discover information associated therewith. The user of the mobile device does not have to type, speak or otherwise specify keywords as search criteria. The search criteria can be merely the virtual beam itself. Search results are generated at a remote server system and communicated back to the mobile device, and then presented to its user in visual, audible and/or other format.

The technique introduced here includes a method and a corresponding device and apparatus (e.g., a server system and/or a mobile device), that includes or performs operations as follows.

In one aspect, the technique includes receiving, at a computer system (e.g., a server system or another mobile device), data indicative of a pointing vector of a mobile device, and defining, by operation of the computer system, a region of physical space as a search region, based on the data indicative of the pointing vector of the mobile device. The technique further includes executing a search, by operation of the computer system, of a database of items tagged with real-world location data, to identify an item associated with the search region, and sending a result of the search from the computer system to the mobile device, the result identifying the item.

The items tagged with real-world location data in the database can represent physical objects and/or non-physical objects or items. The search region can be a two-dimensional region or a three-dimensional region (e.g., along altitude lines).

Execution of the search can comprise identifying, in the database, items that have corresponding physical locations that satisfy a defined spatial relationship criterion relative to the pointing vector. Further, defining a region of physical space as the search region can comprise mapping the pointing vector of the mobile device to a search region of a previously-executed search, wherein executing the search can comprise identifying physical objects (or virtual objects in some embodiments) associated with the search region of the previously-executed search.

The method can be performed in response to a search request from the mobile device. The data indicative of the pointing vector of the mobile device can comprise data explicitly specifying a vector. Alternatively, or additionally, the data indicative of the pointing vector of the mobile device can comprise data specifying a position and orientation of the mobile device, where the method can further comprise computing, at the computer system, the pointing vector of the mobile device, based on the data specifying the position and orientation of the mobile device.

The search region can be defined to include the position of the mobile device, or it can be defined not to include the position of the mobile device.

In another aspect, the technique introduced here includes a method, and a corresponding apparatus (e.g., a mobile device), that includes or performs operations that include sending, from the mobile device to a remote computer system (e.g., a server system), data indicative of a pointing vector of the mobile device, in association with a search request initiated by a user of the mobile device, the data for use by the remote computer system to define a region of physical space as a search region based on the pointing vector. The technique further comprises receiving, from the remote computer system, a search result identifying an item associated with the search region, in response to the search request, and outputting an indication of the search result to a user of the mobile device, the indication of the search result identifying the item.

In another embodiment, the above described process can be reversed, and that it can be initiated from the server rather than from a mobile device.

As in the previously mentioned aspect, the item can be, but is not necessarily, a physical object. The search region can be a two-dimensional region or a three-dimensional region. Executing the search can comprise identifying, in the database, items that have corresponding real-world locations that satisfy a defined spatial relationship criterion relative to the pointing vector. Furthermore, defining a region of physical space as the search region can comprise mapping the pointing vector of the mobile device to a search region of a previously-executed search, wherein executing the search comprises identifying items associated with the search region of the previously-executed search.

The data indicative of the pointing vector of the mobile device can comprise data explicitly specifying a vector and/or data specifying a position and orientation of the mobile device.

Other aspects of the technique will be apparent from the accompanying figures and detailed description.

### BRIEF DESCRIPTION OF THE DRAWINGS

One or more embodiments of the present invention are illustrated by way of example and not limitation in the figures of the accompanying drawings, in which like references indicate similar elements.

FIG. 1 is a high-level illustration of elements of the Virtual Beam system.

FIGS. 2 and 3 each illustrate a cone shaped virtual beam and associated parameters.

FIG. 4 illustrates the technique for identifying points in 3D space that are located along a virtual beam.

FIG. 5 illustrates a technique for converging two cones, representing an observed virtual beam and an actual virtual beam.

FIG. 6 illustrates an overall process of the virtual beam technique.

FIG. 7 shows an example of the detailed data flow associated with a Virtual Beam search, in relation to functional elements of the system.

FIG. 8 illustrates an example of a beam farm.

FIGS. 9 and 10 illustrates different examples of virtual beams associated with performing searches from mobile devices.

FIG. 11 shows examples of graphical user interface (GUI) displays that may be generated by a Virtual Beam Client, to enable the user to specify the shape and other parameters of the search (virtual) beam.

FIGS. 12 through 29 show additional examples of mobile device GUI displays associated with the techniques introduced here.

FIG. 30 is a high-level block diagram showing an example of the functional elements of a VB Client.

FIG. 31 is a high-level block diagram showing an example of the functional elements of the VB Server.

FIG. 32 is a high-level block diagram showing an example of the hardware elements of a mobile device in which a VB Client resides.

FIG. 33 is a high-level block diagram showing an example of the hardware elements of a server computer in which at least a portion of the VB Server resides.

### DETAILED DESCRIPTION

References in this description to “an embodiment”, “one embodiment”, or the like, mean that the particular feature, function, structure or characteristic being described is included in at least one embodiment of the present invention. Occurrences of such phrases in this specification do not necessarily all refer to the same embodiment. On the other hand, such references are not necessarily mutually exclusive either.

### I. Overview

In this description the capitalized term “Virtual Beam” is used to refer to the techniques, apparatuses and devices disclosed herein, collectively and individually, to facilitate explanation. Virtual Beam provides a new and simplified approach to mobile search. It enables essentially any smartphone (e.g., Apple iPhone or Google Android based phone) or other type of mobile device (e.g., laptop computer, notebook computer, tablet) to act as a pointing device equipped with integrated search tools, to search and discover information.

In one embodiment, pointing a suitably configured mobile device in a particular direction (possibly in conjunction with a separate triggering input) simulates the sending out of a beam from the mobile device. The beam is virtual, so no actual source of light or other radiated energy is needed to create it (other than that which is conventionally used to communicate over a wireless medium). This virtual beam can have user-configurable parameters, such as shape, depth, radius, radius expansion ratio, and precision. A search using this technique identifies objects and/or other items that have a specified spatial relationship to the virtual beam (e.g., are present within or in close proximity to the virtual beam). Hence, the mobile device can thereby essentially be used as a point-and-click search device. The user of the mobile device does not have to type, speak or otherwise input keywords as search criteria; the virtual beam itself can be the search criteria.

In one embodiment, search results are generated at a remote server system and communicated back to the mobile device, and then presented to its user in visual, audible and/or other format. The search results can include pointers or handles to data records that contain additional information on objects or items of interest, which the user can select to retrieve additional information on such object or items. Search result can also come from data saved on the mobile device. Note that in certain embodiments, one or more clients and servers may collaborate to perform the tasks described herein in a desired fashion. For example, private information and other sensitive data on mobile objects, such as friends, can be kept on the phone itself and only shared with the server as a backup provision.

Virtual Beam devices and apparatuses can be embodied in specially designed hardware (e.g., circuitry), or in programmable circuitry that is programmed/configured with appropriate software, or in a combination of such forms. In one embodiment, the Virtual Beam devices and apparatuses consists essentially of two main components, one which resides in a mobile device and one which resides in a server computer system.

Hence, in certain embodiments Virtual Beam operates according to a client-server model, including both a client component (VB Client) and a server component (VB Server) as will now be described. “Client-server model” here refers to functionality from a request-response point of view; the client sends a request message and the server responds. Note that in certain environments the VB app that and the VB Server can run within the same physical machine (e.g., both within the same computer or a mobile device). These components each can be implemented entirely in programmable circuitry that is programmed and/or configured by software, such that no special hardware, internal or external, is needed by the user to conduct the search. Alternatively, one or both of these components can be implemented in special-purpose hardware, e.g., one or more application-specific integrated circuits (ASICs), programmable logic devices (PLDs), etc., or in a combination of programmable and special-purpose hardware. To the extent the VB Client includes software in a given embodiment, that software can be downloaded to and installed on the mobile device in a conventional manner, i.e., in essentially the same manner as done today with many other types of mobile application software. Such software can be encoded in any of various known or convenient computing languages.

In a generalized form, Virtual Beam provides a mechanism for converting the human act of holding and pointing a mobile device into a search request and then initiating a search that returns information on objects and/or other items in that direction. And, while the following disclosure generally assumes for purposes of description that the mobile device containing the client component is a mobile communications device (e.g., smartphone or the like), it could alternatively be (or additionally include) essentially any other type of portable object suitably equipped or adaptive to provide the functionality described herein. For example, in other embodiments the mobile device could be a modified cane for a blind person, which searches the surrounding area along the trajectory defined by the user and audibly outputs the search results to the user (e.g., through a built-in speaker or through a smartphone via short-range wireless link). In still other embodiments, the mobile device could be, for example, a golf club, eyeglasses, a toy, etc.

In at least some embodiments Virtual Beam is implemented as a distributed platform, in which a user's private data does not leave the front-end device (e.g., mobile device) unless the user opts to share that data. This feature is based on the assumption that the mobile device has sufficient resources in terms of CPU, bandwidth and memory. In particular, data about the relationships between a user and search results (e.g., objects of interest (OOIs)) can be kept on the mobile device, and this can be true for both mobile OOIs as well as static OOIs. This can be achieved by having the mobile device participate in the mapping of relationships.

A. Client Component

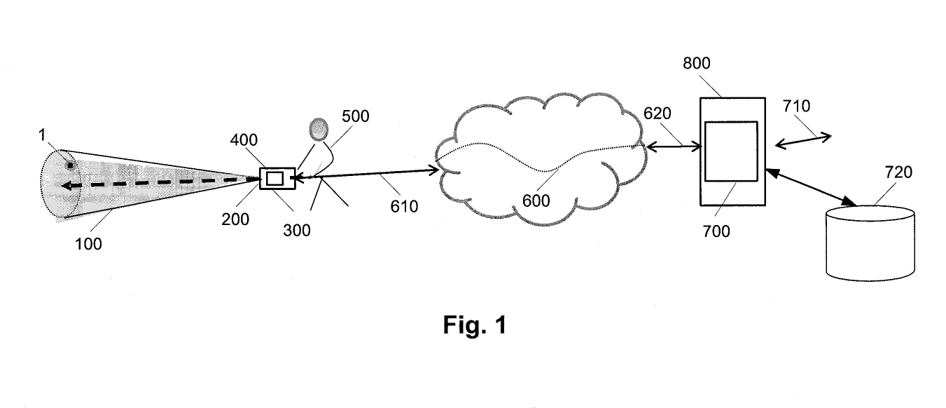

The Virtual Beam client component (also called the “VB Client,” “client application,” “VB Client” or simply “client”) resides in a mobile device, such as a smartphone or the like. Referring to FIG. 1, the main purpose of the VB Client 400 is to gather user input to determine what the virtual trajectory should be, to send that information to the server component (also called the “VB server,” “server application,” “VB Server ” or simply “server”) 700, and to present the results to the user 500. The VB Client 400 is configurable; for example, a user of a mobile device might want his virtual trajectory to cover a certain angular range of degrees, be cone-shaped and have a certain range in meters. The user's real geographic positional coordinates, pointing direction (vector) of the device and other properties are also sent to the VB Server 700 to more accurately retrieve the information for which the user wants to search. The VB Client 400 generates a user interface, such as a graphical user interface (GUI) text, audio, voice, video and/or other type of interface, through which it can interact with the user 500 of a mobile device 300. Among other functions provided by the VB Client 400, it allows filters to be set up or chosen by the user on the mobile device 300 based on the data being returned, to limit and narrow down the search.

Some calculations can be processed on the VB Client 400, but preferably most calculations are done by the VB Server 700. The VB Client 400 can include a downloadable, “lightweight” (i.e., small footprint) software program, e.g., a “mobile application,” that when launched can convert the mobile device it runs on into a pointing device equipped with integrated search tools. Alternatively, the VB Client 400 can be entirely embodied in specially-designed hardware in a mobile device 300.

Virtual Beam can have a default configuration when installed in a mobile device 300, which can be modified and subsequently reset to the default. For example, the default shape of the virtual trajectory might be cone-shaped with a range of 200 meters. Other examples could be a bubble, cube, or ring. Furthermore, the direction of the virtual trajectory from the mobile device itself can be modified.

B. Server Component

The VB Server 700 is a distributed computing system, referred to as the “backend system,” that includes a collection of application support systems, which may include software programs and other logic that process search requests received from VB Clients in different mobile devices. The VB Server 700 maintains a three-dimensional (3D) model of the real world, runs mathematical functions to model a virtual beam 100, executes the searches, and returns the search results to the requesting VB Clients. The VB Server 700 resides in one or more physical server computers 800, which the case of multiple computers may communicate with each other over one or more conventional communication networks.

The 3D space of some portion of the real world is modeled in the VB and items of interest, each of which is tagged with 3D geographical location coordinates (“geo-tagged”). In an alternative, simpler embodiment, the real world can be modeled in two-dimensional (2D) form, for example by omitting altitude/elevation information. The mathematical calculations can be performed on one or more mobile devices 300, on the VB Server(s) 700, or combination thereof. For example, data retrieved from the VB Client 400 can be used to determine collision detection with the earth, with the surface of a building, etc. In other words, given the known shape of the virtual beam (e.g., a cone), the area or volume shared between the virtual beam and an object can be determined, and the search can be confined to that shared area, for example, the fifth through eighth floors of a 20-story building). It is also possible to retrieve information on empty space as well, such as in the case of when the user points to the sky or the ocean.

The amount and nature of information gathered and stored by the Virtual Beam process depends on several factors, including shape and other properties of the virtual beam 100. Generally, the larger the volume (coverage) of a virtual beam, the more data the VB Server 700 may have to search and analyze. However, larger coverage does not necessarily translate into a larger dataset or longer system response times. For example, a virtual beam 100 with a very large coverage area may not discover much information if the user has previously narrowed the search criteria (e.g., through setting user preferences or selecting a pre-search filter criterion), for example, an interest in only historic man-made landmarks, or if the virtual beam is directed at a relatively empty region of space.

C. User Operation:

Virtual Beam is easy for an end user to use and eliminates the need for the user to enter text, upload media such as photos or video, or speak, in order to discover the world around him. The user 500 needs only to point his mobile device 300 in the direction of objects or a region of space in which he is interested, to retrieve information. Pointing does not necessarily require that the user hold the device; for example, the mobile device can be placed on a table or carried in a pocket.

The VB Client 400 sends to the VB Server 700 data indicative of a “pointing vector” of the mobile device 300. The pointing vector is used by the VB Server 700 to determine a region of space (the “search region”) in which to search for objects or items of interest in the VB Server's database 720. The search region for a given search request can be, but is not necessarily, the virtual beam 100 for that search request.

The data indicative of the pointing vector may specify the pointing vector directly, or it can be data from which the VB Server 700 can compute the pointing vector, such as the current location and orientation (tilt angle(s)) of the mobile device. Most modern mobile communication devices such as smartphones and the like include location determination devices such as global positioning system (GPS) chips/receivers. Furthermore, sensors which can detect the angular orientation (tilt) of a mobile device are becoming increasingly more common in such devices. This functionality may be supported by the host mobile device implemented through an application programming interface (API), operating system call, or other mechanism.

Location and tilt can alternatively be entered manually, automatically polled from a third-party remote or local database, or set randomly or selectively. If no GPS or other similar location service is supported by or available to the mobile device, the VB Client 400 can look for alternative services and capabilities that the host offers to determine its location. One possible alternative technique to estimate the location of the mobile device is to analyze the quality and contents of cellular and wireless signals and messages the antennas receive, e.g., by triangulation. The details of how a mobile device's longitude, latitude, and/or altitude are measured are not germane to the technique introduced here. It is assumed that the VB Client 400 can compute or access this data.

D. Illustrative Use Cases:

Objects of interest to the user may include buildings and other structures. For example, a user may want to know the name of a landmark that he sees across a river, and therefore he points his mobile device toward the landmark. Or, a user may want to know when the next train is leaving the station. The user may be wondering, “Wasn't the movie ‘Gone with the Wind’ filmed in a city nearby?”, or “what's the temperature at 30,000 feet high above where I'm currently standing?” The user may want to scan a nearby high-rise building to identify businesses on each floor. All of these questions/interests can potentially be answered by using the Virtual Beam search technique, i.e., by using the mobile device to define a virtual beam, which defines a spatial region for the VB Server to search.

Virtual Beam eliminates the need for the end user to enter voice, audio, image or text as search keywords. With Virtual Beam, the search criteria or patterns are not text, voice, audio, image or video (nor other form of digital data that is typical today), which are what the back-end servers of conventional search providers such as Google, Microsoft, and other search engines expect to receive from the user (through a browser for example).

The system can support various different shapes and forms of virtual beams and allow the user to define new beam shapes. The amount of information returned by an initial search conducted on all objects that may qualify as candidates to return in a search result is often proportional to the coverage size of the virtual beam. However, a larger beam coverage area does not necessarily result in a larger results set, such as when the beam is pointed at a large, relatively empty area, such as the sky or the ocean, the amount of information in the result set may still be relatively small.

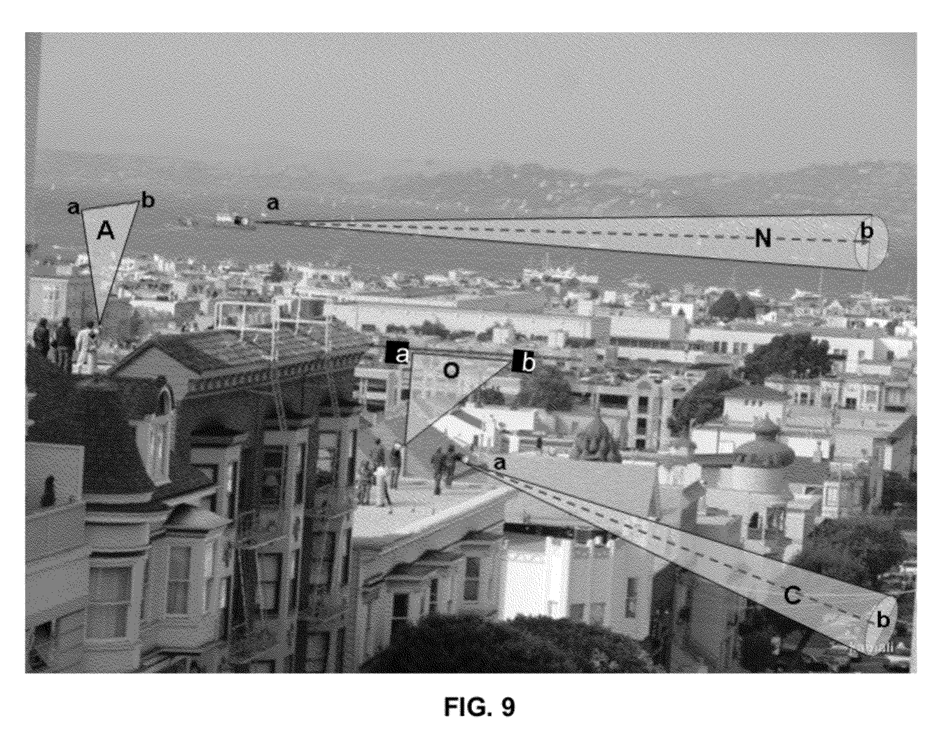

To illustrate different usage scenarios, FIG. 9 shows four different virtual beams, i.e., virtual beams A, C, N and O, corresponding to four different users running the Virtual Beam client on their mobile devices. Beam A illustrates running a search along or in close proximity to line “ab.” Beam N represents a virtual beam with form set to “3D-cone” and range set to 10 miles. Beam C represents a virtual beam with form set to “3D-cone” and range set to “very short”. Beam O illustrates running a search along or in close proximity of line “ab.”

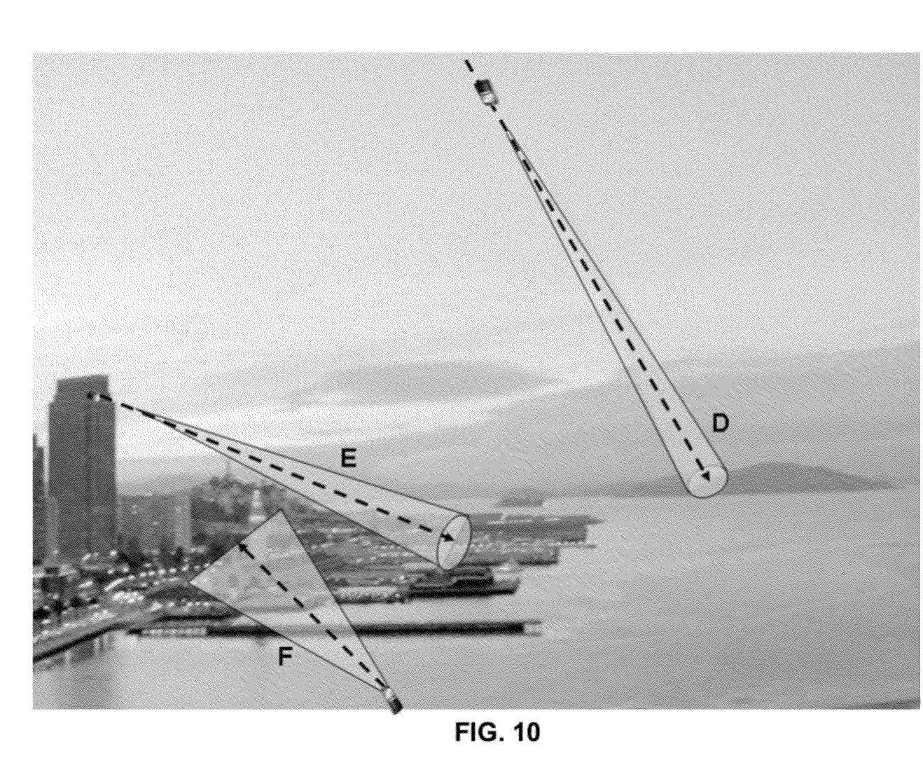

One benefit of Virtual Beam is that it enables types of searches that were impossible or impractical before. For example, FIG. 9 shows an east-looking view of part of the city of San Francisco and San Francisco Bay. A single search request with virtual beam N (which points roughly southward) in FIG. 10, with range set to about 30 miles, could return information about the Bay Bridge, the San Mateo Bridge and the Dumbarton Bridge.

FIG. 10 shows examples of other possible usage scenarios. A user associated with Beam D is on a plane and points his smartphone to the island below to initiate a virtual beam search to obtain information on real estate properties (home prices, for-closures, etc) on the island. Another user, associated with Beam E, is on top floor of a tall building and aims his smartphone at what appears to be an entertainment area on a pier below, to obtain information on attractions, restaurant menus, discounts or coupons, etc. A third user, associated with Beam F, is driving on a bridge and is pointing his mobile device at a ferry terminal building to look up departure times for the next ferry leaving for a nearby port.

E. Benefits/Advantages

Virtual Beam technology is complementary to existing search solutions and fills a gap by adding the capability to search a portion (a “subspace”) of real-world space. It can have a simpler user interface than conventional search engines, since it eliminates or shortens time-consuming steps.

The Virtual Beam search technique is also different from that of navigation systems in which the current location of a device (the host) is superimposed on a background-static map that is rendered either horizontally (such as in vehicles equipped with navigation systems or Google Maps running on a smartphone), or vertically (such as in applications that render a 3D view of the sky showing location of stars in relation to User's own location).

Virtual Beam is more focused and directed than existing search mechanisms. Virtual Beam search is concerned with searching inside of (or close to) a 2D or 3D region of space designated by the end user, e.g., along a vector. This approach adds a new dimension to search, allowing new forms of search that have been impossible in the past. Virtual Beam thus simplifies search; it complements conventional search techniques, allowing the human to do more efficient and selective search and to make more meaning full sense of search results.

### II. Detailed System Operation

FIG. 1 is a high-level illustration of elements of the Virtual Beam system. The system includes at least one VB Client 400 which resides within a mobile device 300 (e.g., a smartphone), and the VB Server 700 which resides within a back-end server computer system 800. The VB Client 400 communicates with the VB Server 700 through an interconnect 600, which may be or include one or more of various types of communications networks, such as a cellular telecommunications network, the Internet, one or more local area networks (LANs), etc. The VB Server 700 has an external interface 710 to other processing systems from which it can receive data, such as data about places and items of interest for populating the backend search database 720. In one embodiment the VB Server 700 is connected to the interconnect 600 through a backend Internet service provider (ISP) interface 620, while the mobile device 600 is connected to the interconnect via a wireless (e.g., cellular) communications link 610.

To the extent the VB Client 400 includes software in a given embodiment, such software can be downloaded and installed on the mobile device 300 in essentially the same manner as any other mobile application software.

In one embodiment, every search that the system conducts has a corresponding vector, V, in 3D space, which may originate from the mobile device 300. A Virtual Beam search can be triggered by a human user or by a machine. Examples of a machine-triggered search can be where an automobile is finding its way through obstacles, or where a small plane is searching for suitable place to land. In one embodiment, the user 500 triggers a search by pointing or aiming the mobile device 300 at a specific target 1 (an object of interest) or simply in a particular direction corresponding to the vector, V. A search request initiates a search process in which both the VB Client 400 and the VB Server 700 participate. Although the process can start with the action of pointing mobile device 300 in a particular direction or at a particular target 1, it can also be triggered by scheduled or ad-hoc search requests. The target 1 (if any) can represent a particular point, or it can represent any point in 3D space with coordinates (x, y, z) within a defined coverage or range of the virtual beam.

A search using Virtual Beam can, depending on implementation, identify real objects and/or other things that are not necessarily objects (e.g., the sky) or not even necessarily physical things (e.g., a service or sale being offered by retail establishment). The search identifies such objects and other things based on their having some specified spatial relationship with the virtual beam, e.g., being present in or close to the virtual beam itself, or being present in or close to a defined region of space that contains or is intersected by the virtual beam.

Another benefit of the Virtual Beam system is that, as the number of VB Clients in use grows, the likelihood that pointing to a person or a device will retrieve information about that person or device increases. This is based on the assumption that both the pointing source and the destination (target) and their coordinates would be known to the system. Hence, if the system identifies a person close to or within the virtual beam, it could then fetch and provide information about that person, just as it does for fixed objects such as buildings, landmarks, etc.

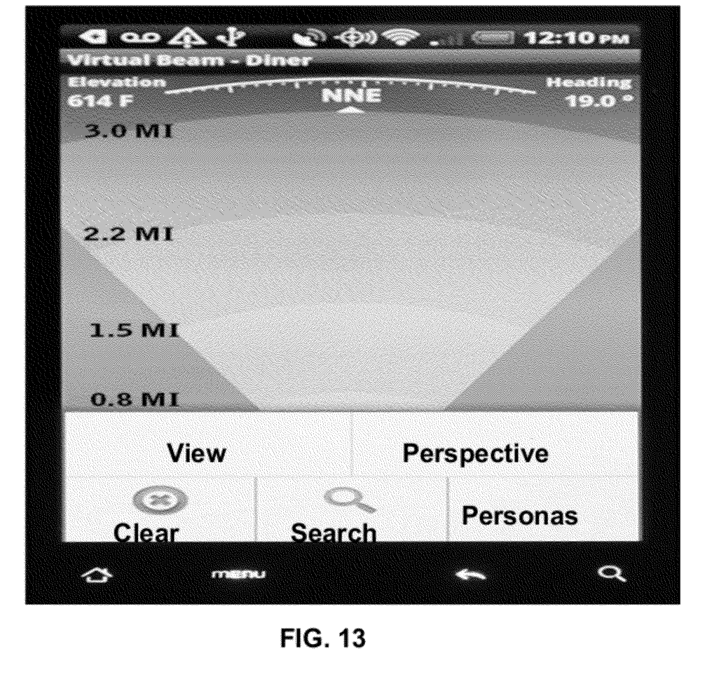

In one example of a use scenario, the user 500 launches the VB Client 400 (e.g., a client-side Virtual Beam application) by, for example, touching an appropriate application icon or by selecting an item from an item list or pull-down menu displayed on a display device of the mobile device 300. The user 500 then points the mobile device 300 at an object of interest or in some direction of interest. As noted above, the default behavior can be to hold the mobile device 300 like a TV remote control with the front of the device facing the target or direction of interest. The user then activates a “Search” button or icon (or other suitable control) such as shown in FIG. 13.

The VB Client 400 may assist the user during this process. The assistance may include running a quick “beam check” first, which helps verify if the direction calculated by the Client is “acceptable” to the user. The beam check is a useful tool when there is doubt about whether the direction is correct.

Once the “Search” button/icon is activated, the VB Client 400 constructs a short message to the VB Server 700, which (as described further below) may contain one or more of the following types of information: the location and orientation (tilt angles) of the mobile device, identifier (ID) of the user, application ID of the VB Client, ID of the mobile device, and possibly one or more optional parameters such as the offset of the virtual transceiver from the mobile device (i.e., a different origination point of the virtual beam). This message is then sent over the wireless network and/or any other available data network (e.g., Internet) to the VB Server 700.

Interactions between the VB Client 400 and the VB Server 700 can be mostly if not entirely hidden from the user. The user experience can be made to be similar to that of conventional search engines, at least to the extent that the user provides the search engine with some search criterion, activates a control to initiate a search, and then looks for search results to appear on the screen, or presented audibly, etc. More specifically, the user can simply point the mobile device and activate a designated control to trigger a search, or in some embodiments, simply point the mobile device to trigger a search. No text or other explicit user input needs to be entered as search criteria.

The VB Client 400 can also run in the background, without using a graphical user interface, and/or can operate to provide data to other applications or services.

This was about holding the phone like a camera as opposed to holding it like a remote control. VB Client allows the end User to modify the placement of the “virtual transceiver.” Running in “camera mode search results can be shown on a real life picture (e.g., by setting the virtual beam's origination point parameter to “Front Camera”, “main camera,” etc).

Other actions the user can perform using the VB Client 400 include stopping an in-progress search, focusing on an object of interest in a search result output, locking the virtual beam (e.g., locking the direction of the virtual beam and search within the volume), locking the target (e.g., search within the volume of a target, say search for coupons in a given store, the target), etc.

A. Beam Modeling

In one embodiment the VB Client 400 calculates properties of a virtual beam 100 at a given direction or along a given trajectory. The user may be pointing at a specific point or object of interest or just requesting a general search on potential objects of interest in some arbitrary direction. The virtual beam 100 can be modeled as a ray or vector (“pointing vector”) emanating from one end of the mobile device 300, or as a 3D shape occupying a portion (“subspace”) of real world space, with a defined volume.

Referring to FIGS. 1 and 9, a virtual beam 100 can be modeled as a line defined from a first point “a” to a second point “b” in space along the beam; see FIGS. 9 and 10 for examples of virtual beams. Point “a” can be, but is not necessarily, collocated with the mobile device. Point a in at least some usage scenarios can be thought of as the location of a virtual transceiver 200 in the mobile device 300. Point “b” may represent a particular target point (or object of interest) or merely the end of directed line (vector) ab. The VB Client 400 provides the user with the ability to specify a different location for point “a”, i.e., other than at the mobile device 300. Hence, the VB Client 400 can run on a mobile device 300 in one location and request that the search to be conducted as if the mobile device 300 were located somewhere else.

Using location coordinates of the mobile device 300 (e.g., obtained through GPS or other system/mechanism) as well as other data such as the tilt angle(s) of the device, the VB Server 700 calculates a mathematical function, F(Beam), that defines the virtual beam 100 for a given search request, as described in greater detail below. The VB Client 400 or the user 500 can choose or change the shape, type, range, depth, breadth, etc. of the virtual beam 100. Software and/or hardware for use in calculating F(Beam) may reside in the VB Client 400, in the VB Server 700, or distributed in both the VB Client 400 and the VB Server 700.

The VB Client 400 can take a particular side of the mobile device 300 as the default point from which the virtual beam 100 emanates, i.e., the location of a virtual transceiver that produces the virtual beam, which may be the front side for a smartphone. The “front side” in this context means the side or edge of the mobile device which is farthest from the user when the user holds the mobile device with its main user interface surface (e.g., its main display) on top and parallel to the ground. This would allow the user to use the mobile device somewhat like a TV remote control (i.e., by pointing it at objects and in different directions of interest), to conduct searches on his environment. Note that the default emanation point alternatively can be a side or edge of the device other than the front side.

The VB Client 400 provides the user with GUI-based tools to define and change the position of the virtual transceiver (e.g., front, through the main camera, etc.) and the angle of the virtual beam (virtual signal).

The VB Client 400 provides the user with GUI-based tools to define the shape and other characteristics of the virtual beam, i.e., to designate a 2D or 3D search space. The search process thereby can be bounded (either strictly or loosely) by the volume of space that the corresponding virtual beam would occupy in the real world. Search preferences, categories, and/or other parameters or settings can be set by the system (for the user) or by the user directly. Some preferences set by system can be inferred from a user's “persona” (a user-customizable, learning search filter), location, status, mood, search history, etc. (e.g., “traveling” location is: Bay Bridge).

The VB Client 400 and/or VB Server 700 implement algorithms that can produce and calculate a mathematical formula, F(Beam), that defines a virtual beam for a search request.

The VB Server 700 also implements methods and algorithms that take the formula of a virtual beam as input and then discover and identify objects and/or other items of interest and return the results to the mobile device as a search result. The data that populate the database 720 from which the search results are produced can come from any known or convenient information source(s), which may include one or more third-party information providers. As noted above, in addition to real objects, the database 720 can alternatively, or additionally, include data representing non-real/virtual objects and/or other types of items, all associated with real-world physical locations (e.g., geo-tagged, 3D zone, zip code, street address).

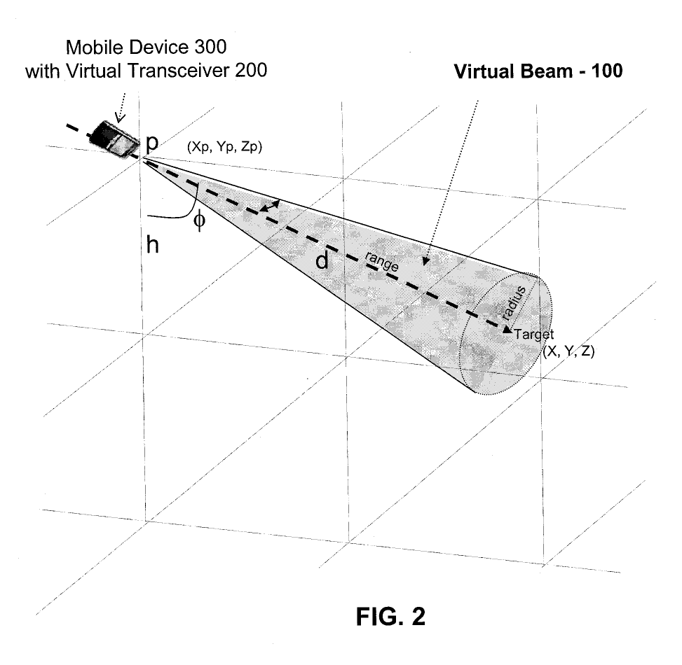

As mentioned above, a virtual beam can have any of various different shapes and properties. One possible shape is a cone shaped beam, as shown in FIGS. 1, 2, 10, etc. With the location p (xₚ, yₚ, zₚ) and orientation angles (φ, θ) of the mobile device 300 and placement of the source of the virtual transmitter 200 known, the VB Server 700 can run the search algorithm.

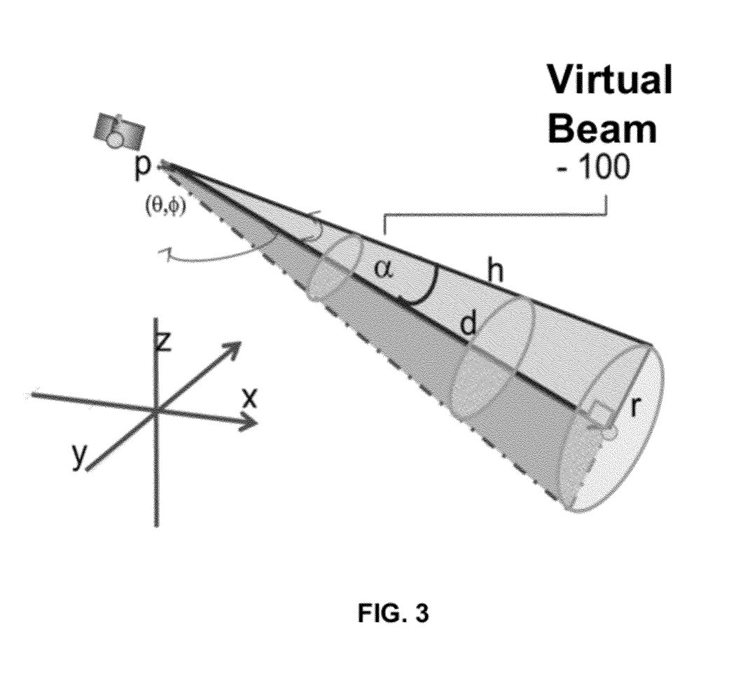

Knowing the location and orientation of the mobile device and optionally other parameters, the VB Client 400 or VB Server 700 calculates the function F(Beam) that defines the virtual beam as a vector starting at point p and projecting at a particular angle(s) in 2D or 3D space. For example, referring to FIG. 3, with coordinates of starting point p and projection angles φ and θ known, and default or user-specified values for beam radius r, depth d, length h, and/or the shape of the beam, the server (or the client) can easily calculate the function F(Beam) for the virtual beam using relatively simple geometry and trigonometry. The angle α is the angle between the cone axis and the cone generator or surface.

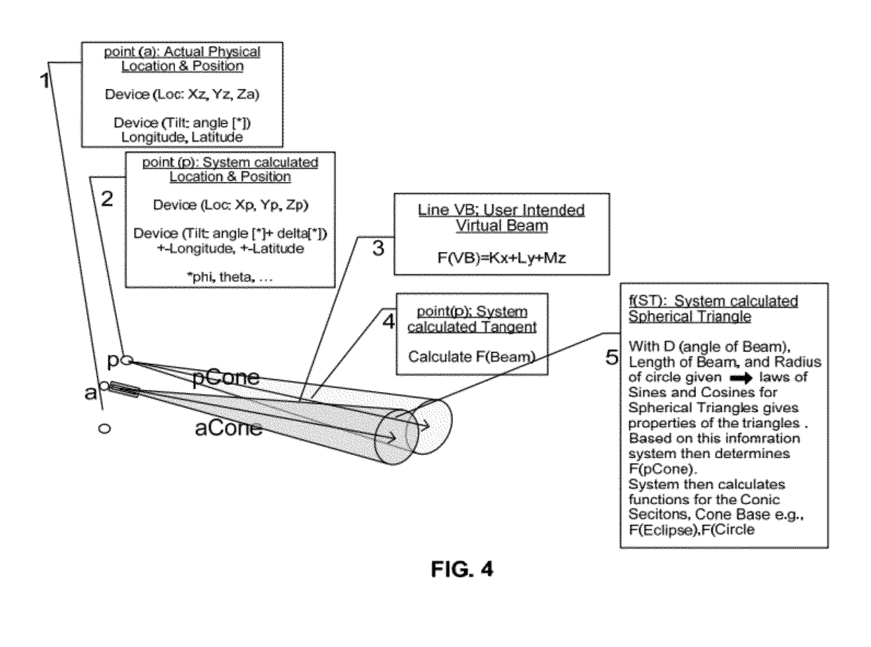

FIG. 4 illustrates the technique for identifying points in 3D space that are located along a virtual beam, e.g., points that are on a conic section. A cone is one example of the shape of the virtual beam. The system may alternatively (or additionally) calculate functions for any of various other beam shapes, such as a ray, a circle, a “bubble” (sphere), a ring that has a defined width and is centered about the mobile device, a stripe of defined width centered on or offset a defined distance from the mobile device, etc. A “ring” in this context can be defined as the space bounded by two concentric circles in two dimensions. However the boundaries need not necessarily be a circle and can assume any other shape, such as an ellipse or rectangle. The concept can also be extended to 3D, for example, a cone that is intersected by two planes. The volume enclosed by the two planes and the cone define a ring. Another example is the volume enclosed by two concentric spheres.

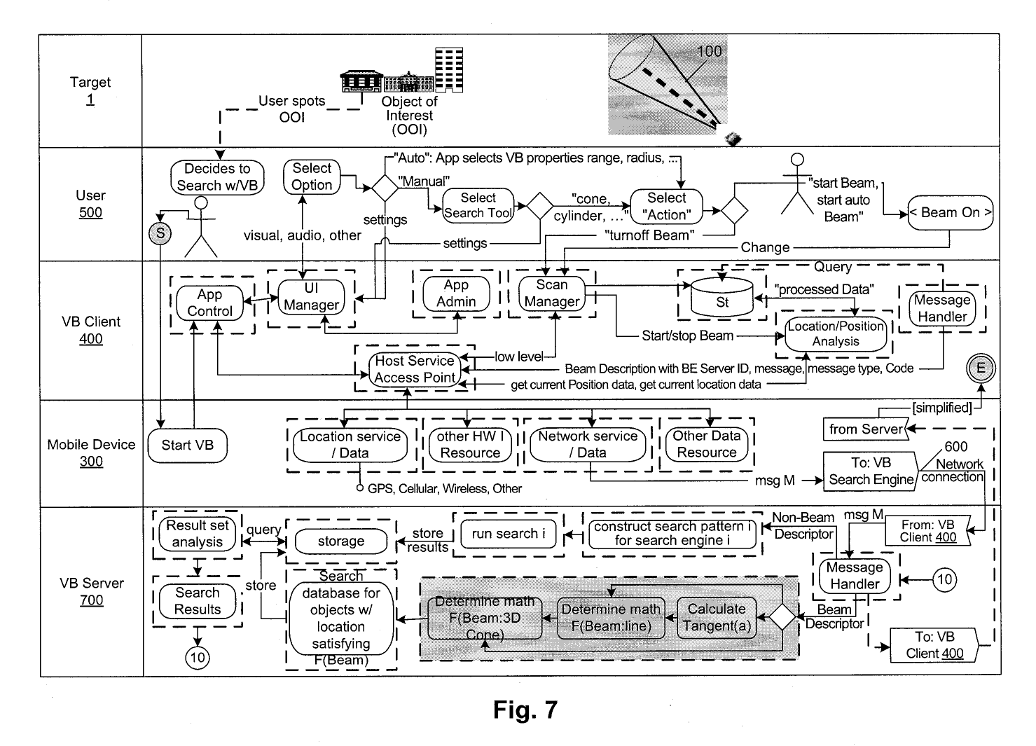

The algorithm that determines the function F(Beam) may execute entirely in a mobile device 300, in the VB Server 700, or in a combination thereof. The steps to determine a sample F(Beam) are straightforward and are illustrated as steps 1 through 5 in FIG. 4 (discussed below) and in the process flow in FIG. 7. The system can use polar geometry and trigonometry to calculate functions for the virtual beam as, for example, a line, a 2D plane, an ellipse, a sphere, a cone, or other type of object, based on search context.

FIG. 4 illustrates a method to compute the function F(Beam) for a virtual beam, which in the illustrated example has the shape of a cone. The identifier aCone represents the user-intended virtual beam originating at point a, whereas the identifier pCone represents a system-calculated beam or estimated beam originating at point p. Two separate beams (aCone and pCone) are defined to compensate for possible errors in the subsystem for estimation of location, tilt, and/or other aspects of the mobile device. Therefore, pCone represents the observed cone (as reported by the mobile device) and the aCone represents the actual cone. The difference between the two cones can be accounted for through a calibration mechanism. Therefore, the parameters reported by the mobile device, i.e., tilt, latitude, longitude, altitude and cone angle, fully define the pCone. The parameters needed for the aCone are derived from the calibration data and the pCone parameters. The direction of the axis of the cone can be determined from the tilt angle, therefore, the parameters K, L, M (see below) which define the cone axis can be easily calculated.)

Point a in FIG. 4 represents the actual physical location of the mobile device, Device (Loc: Xa, Ya, Za) (e.g., latitude, longitude and, optionally, elevation), which at step 1 is communicated to the server along with the tilt angle(s) of the mobile device, Device (Tilt: angle [φ, θ]). At step 2 to the VB Server computes the location of point p, Device (Loc: Xa, Ya, Za), and the tilt angle associated with pCone, i.e., Device (Tilt: angle [φ±Δ_{φ}, θ±Δ_{θ}]). Once the error due to the location subsystem or other device hardware is known, the computation of these parameters can be a simple geometric calculation. At step 3 server computes the line V^{B} defining the center axis of the user-intended virtual beam, aCone, according to the formula F(V^{B})=Kx+Ly+Mz, where Kx, Ly and Mz are the coordinates defining the cone's axis position. At step 4 the system then computes the Tangent for point p and calculates F(Beam). Finally, at step 5, given D (angle of beam), the length of the beams, and radius of the circle, using the laws of sines and cosines for spherical triangles the system computes a spherical triangle for each of aCone and pCone. Based on misinformation, the system then determines F(pCone). The system then calculates functions for the conic sections, cone base, e.g., F(ellipse) or F(circle).

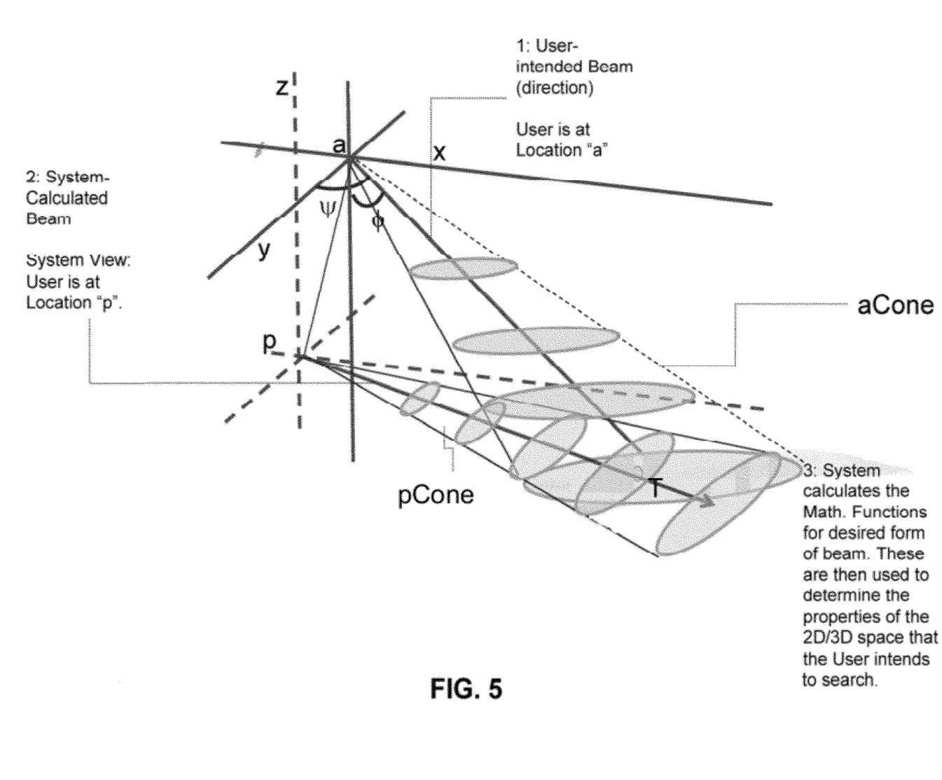

FIG. 5 illustrates a technique for converging two virtual beams, i.e., aCone and pCone.

B. Client-Server Messaging

In one embodiment, the VB Client 400 communicates with the VB Server 700 by sending Virtual Beam Request Messages (VBRMs) to the VB Server 700 over the interconnect 600 (see FIG. 1 and bottom lane in FIG. 7). Each VBRM contains one or more of the following information elements:
Location of the Device
Tangent [ ]: The angles collectively representing the tilt of the mobile device, e.g., the cone axis. May be mandatory in at least some embodiments if location coordinates of a target are not present in the search request.
Shape: Optional—specifies geometrical aspects of the subspace under search.
Radius: Optional
Granularity: Optional
Target Location [ ]: location estimate (x, y, z) for target point T. May be mandatory in at least some embodiments if Tangent [ ] is not present in the search request.
Expansion Ratio: Optional
Precision: Optional
Virtual Transceiver Location: Default is front side of the mobile device in one embodiment, but can be set to other values, such as Back, Camera, Side, etc.
Elevation.

The VB Server 700 (in one embodiment) then calculates the mathematical function F(Beam) for the virtual beam, a reference beam, for conic sections, etc., and then returns handles pointers to data records that store information on points or items of interest inside or near the beam. The concept of a “reference beam” is explained below.

C. High-Level Process Flow

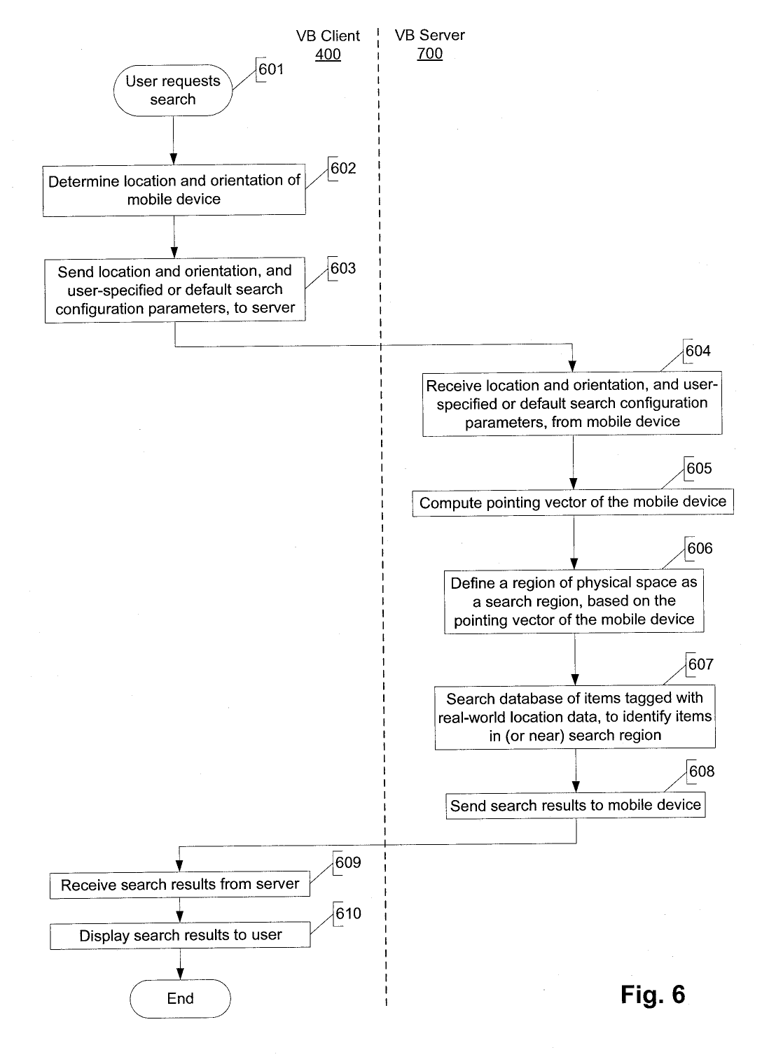

FIG. 6 illustrates an overall process of the virtual beam technique, according to one embodiment. The process is performed partially by the VB Client 400 and partially by the VB Server 700. Initially, at step 601 the user of the mobile device requests a search. This may be done by the user's activating a designated icon or control on the mobile device, for example. Next, at step 602 the VB Client determines the location and orientation of the mobile device. At step 603 the VB Client sends to the VB Server the location and orientation, as well as user specified or default search configuration parameters (e.g., being width, beam shape, beam length). As noted above, this information may be sent in one or more VBRMs.

The VB Server receives this information from the mobile device via an interconnect (e.g., via a cellular network and the Internet) at step 604. At step 605 the VB Server computes the pointing vector of the mobile device from the location and orientation of the mobile device. The VB Server then defines a region of physical space as a search region, based on the pointing vector, at step 606. This step includes, initially, defining the virtual beam for this search request, based on the pointing vector of the mobile device and the other search parameters mentioned above. The search region can be, for example, the volume of space that is exactly coextensive with the virtual beam, or a larger region of space that completely contains the virtual beam, or a region of space that is intersected by or is otherwise spatially associated with the virtual beam. At step 607 the VB Server searches its database of items geo-tagged with real-world location data, to identify those items that represent objects and/or other things that are in (or, optionally, near) the search region. The VB Server then gathers those items (the search “hits”) into a search result set, which is sent to the mobile device at step 608. The VB Client receives the result set at step 609 and displays it (or outputs in some other form) to the user at step 610. Optionally, the user may be able to select one or more items in the result set and request additional information on those items; for example, items in the result set may be displayed as hyperlinks.

### IV. System Architecture

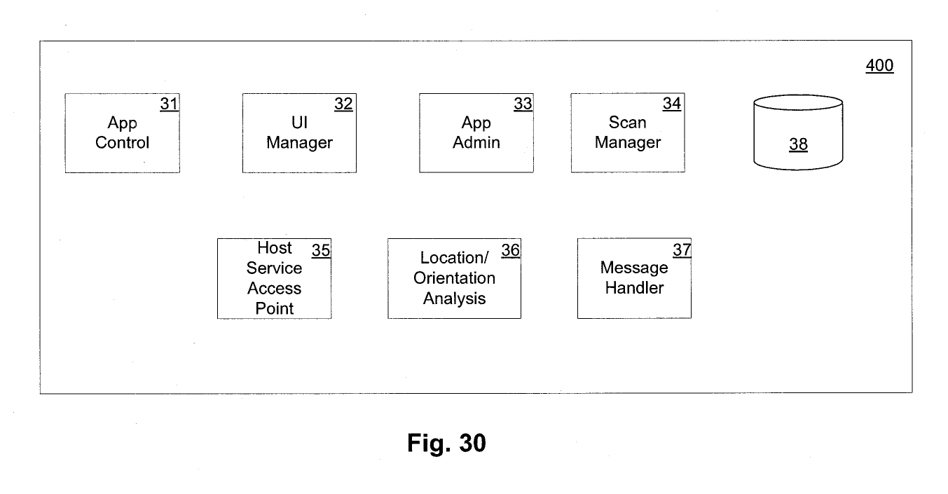

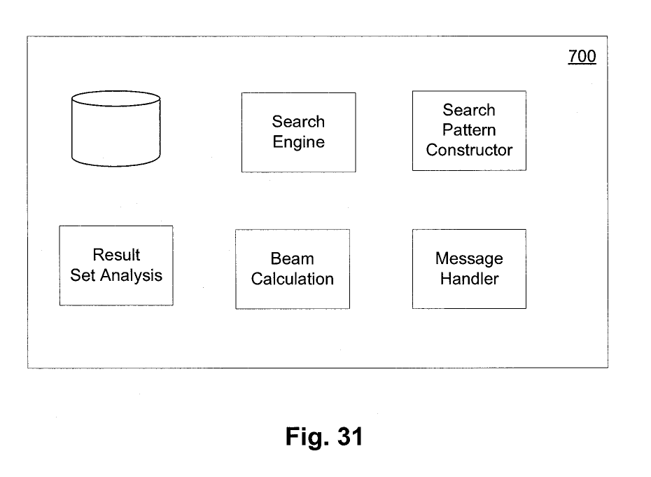

Refer now to FIGS. 30 and 31, which show the major functional elements of the Virtual Beam system, according to one embodiment. FIG. 30 shows the elements of the VB Client 400. The illustrated elements can be embodied in specially designed hardware, or programmable circuitry that is programmed/configured with appropriate software, or in a combination of such forms. In the illustrated embodiment, the VB Client 400 includes an application control unit 31, a user interface (UI) manager 32, an application administrator 33, a scan manager 34, a host service access point 35, a location/orientation analysis engine 36, a message handler 37 and a database 38. The application control unit 31 controls and coordinates the overall operation of the VB Client 400, including keeping track of application properties. The UI manager 32 coordinates interactions between the VB Client 400 and the user. The application administrator 33 is responsible for keeping track of service properties. The scan manager 34 is responsible for scanning for other VB Clients within the search region. The host service access point 35 represents the low-level software interface through which VB Client 400 gains access to the VB Server 700 and requests for services that the host offers. The location/orientation analysis engine 36 is responsible for determining the location and orientation of the mobile device. The message handler 37 is responsible for sending and retrieving messages to and from the server, respectively, including implementation of all of the necessary communication protocols. The database 37 may contain information such as a user profile of the user, which may contain the user's customized personas, search preferences, etc. The database can be a distributed database that may be partially stored on the mobile device 300. In that case, private data may not be allowed to leave the frontend device unless the user opts in to share his data, as mentioned noted above.

FIG. 31 illustrates the elements of the VB Server 700. The illustrated elements can be embodied in specially designed hardware, or programmable circuitry that is programmed/configured with appropriate software, or in a combination of such forms. In the illustrated embodiment, the VB Server 700 includes a search pattern constructor 41, a search engine 42, a database 43, a message handler 44, a beam calculation unit 45, and a result set analysis unit 46. The message handler 44 is responsible for sending and retrieving messages to and from the VB Client 400, respectively, including implementation of all of the necessary communication protocols. The search pattern constructor 41 is responsible for determining the search area taste on the virtual beam. The beam calculation unit 45 is responsible for computing the virtual beam for each search request. The search engine 42 is responsible for actually executing the search on the database 43. The database 43, which may be an embodiment of database 720 in FIG. 1, contains the above-mentioned geo-tagged items that can be retrieved to form a search result set. The result set analysis unit 46 is responsible for the analysis of the data elements the file systems and data repositories returned, and identifying the sub-set of those data elements that would meet the search criteria (e.g., “search all friends who are in the Empire State Building and available for lunch”).

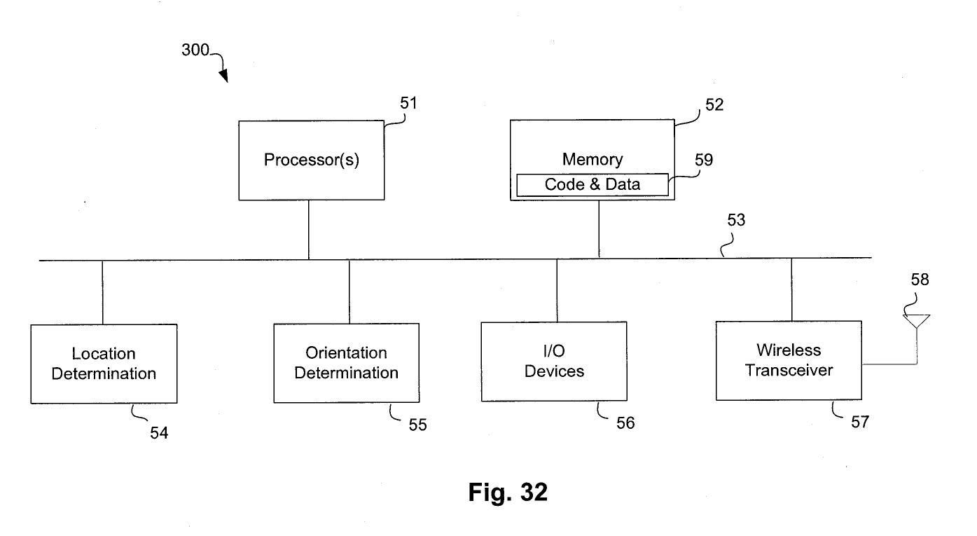

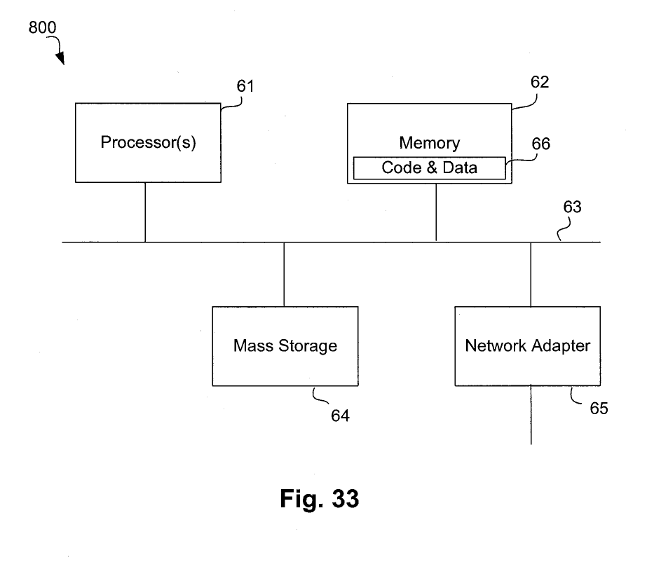

Refer now to FIGS. 32 and 33, which show examples of the major hardware elements of the Virtual Beam system, according to one embodiment. FIG. 32 shows an example of the hardware elements of a mobile device 300 that contains a VB Client 400. In the illustrated embodiment, the mobile device 300 includes one or more processors 51 and memory 52, coupled to each other through an interconnect 53. The mobile device 300 further includes, coupled through the interconnect 53, a location determination unit 54, and orientation determination unit 55, one or more I/O devices 56, a wireless transceiver 57 with antenna 58 coupled thereto.

The interconnect 53 can include any one or more of various known or convenient forms of buses, point-to-point connections, bridges, adapters, and/or or other form or forms of interconnect. The processor(s) 51 is/are responsible for controlling the overall operation of the mobile device 300 and communications with the server-side components. As such, the processor(s) 51 may include, for example, an application processor to control application-level processing and a baseband processor to control wireless communications, etc. The functional elements illustrated in FIG. 30 can be implemented as subsystems within the processor(s) 51. Each such processor 51 may be, for example, a general-purpose programmable microprocessor, a programmable digital signal processor, an application-specific integrated circuit (ASIC), a programmable logic device (PLD), field programmable gate array (FPGA), or the like, or a combination of such devices. The memory 52 stores code and data 59 used by the processor(s) 51, which may include code and data to configure the processor(s) 51 to perform operations associated with the Virtual Being technique.

The location determination unit 54 is responsible for determining the precise location of the mobile device 300 and may be, for example, a GPS chipset. The orientation determination unit 55 is responsible for determining the angular orientation of the mobile device 300 and may include, for example, gyroscopes, accelerometers, or other conventional mechanisms for determining angular orientation. The I/O devices 56 may include, for example, a manual keyboard, buttons and/or other manual controls, a microphone, a display screen (which may be a touch-sensitive display), an audio speaker, or the like.

FIG. 33 shows an example of the hardware elements of a server computer 800 that can contain at least a portion of the VB Server 700. In the illustrated embodiment, the server system 800 includes one or more processors 61, memory 61, a mass storage facility 64 and a network adapter 65, all coupled to each other through an interconnect 63. The interconnect 63 can include any one or more of various known or convenient forms of buses, point-to-point connections, bridges, adapters, and/or or other form or forms of interconnect. The processor(s) 61 is/are responsible for controlling the overall operation of the server system 800 and communications with the mobile device 300. The functional elements illustrated in FIG. 31 can be implemented as subsystems within the processor(s) 61. Each processor 61 may be, for example, a general-purpose programmable microprocessor, a programmable digital signal processor, ASIC, a PLD, FPGA, or the like, or a combination of such devices. The memory 62 stores code and data 66 used by the processor(s) 61, which may include code and data to configure the processor(s) 61 to perform operations associated with the Virtual Being technique.

The mass storage facility 64 can be used to store large volumes of data needed or maintained by the server system 800, such as database 43 or 720. The network adapter 65 is used by the server system 800 to communicate with external computer systems and/or other devices (including the mobile device 300, albeit indirectly) via a network. The network adapter 65 may be, for example, an Ethernet adapter, cable modem, wireless transceiver, or other similar device(s).

### V. Detailed Process Flow

FIG. 7 shows an example of the detailed data flow associated with a Virtual Beam search, in relation to the functional elements shown in FIGS. 30 and 31. The illustrated flow starts at point “S” and ends at point “E”. The flow starts when the user 500 spots an object and launches the Virtual Beam (“VB”) application (client 400) on the mobile device 300. It ends when the search results are returned to the mobile device 300.

Note that the client 400 that sends the VB search request to the Server and the Client that receives the search results may be different clients that run on different hosts. Note that in the illustrated flow the mathematical functions associated with the search are performed by the Server. In other embodiments, however, these functions could run partially or completely on the Client. Note also that Virtual Beam search requests do not have to originate from a smartphone or a sophisticated hardware device.

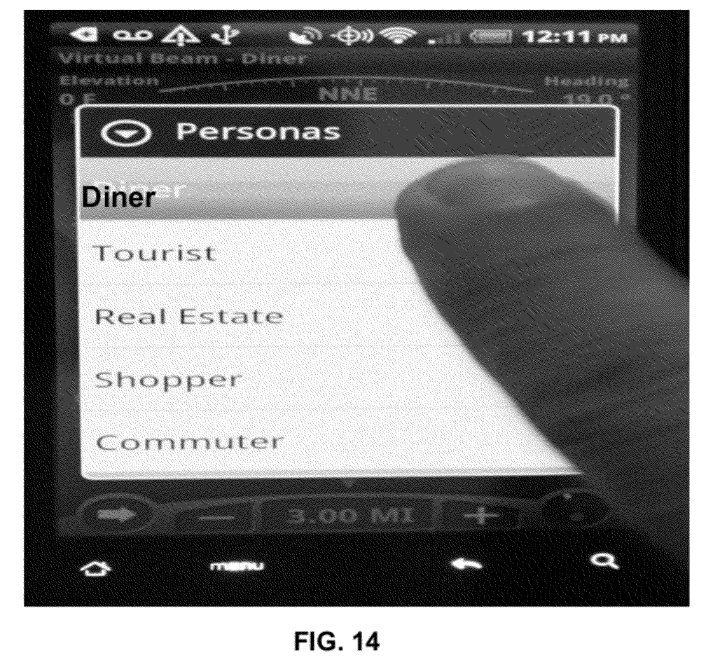

The user 500 can also select the shape of the virtual beam 100 (e.g., cone, cylinder, line, dots) and other parameters, such as beam length/range, beam dispersion angle, etc. To initiate the search, the user 500 simply activates a control on the mobile device (e.g., the “Search” touch icon shown in FIG. 14) while pointing the mobile device 300 at a target (object of interest) or just in a direction of interest.

### VI. Reference Beams

In one embodiment, after the function F(Beam) of a virtual beam is calculated, the VB Server 700 executes an algorithm that takes that function as input and outputs references to one or more equivalent virtual beams, called “reference beams.” Reference beams are virtual beams associated with searches previously conducted by the system, which may be searches done in response to user requests or searches scheduled by the system. These reference beams can be used to speed up the process of producing search results for a given search request. For example, rather than going through the complete process of identifying objects or items of interest that fall within the virtual beam of a present search request, it might be faster for the system to identify a reference beam that spatially corresponds most closely with the virtual beam of the present search and return the search result previously identified for that reference beam as the result of the present search.

Once the function F(Beam) for the user-initiated being is determined, the VB Server can utilize a series of basic math functions (e.g., algebraic vector multiplications, transformations, etc.) to identify similar, equivalent or matching reference beams, which can be vectors. Once final F(Reference Beam) candidates are known (e.g., based on greatest similarity to F(Beam), the VB Server can then choose to include data from the searches associated with those reference beams in the search result.

### VII. Beam Farms

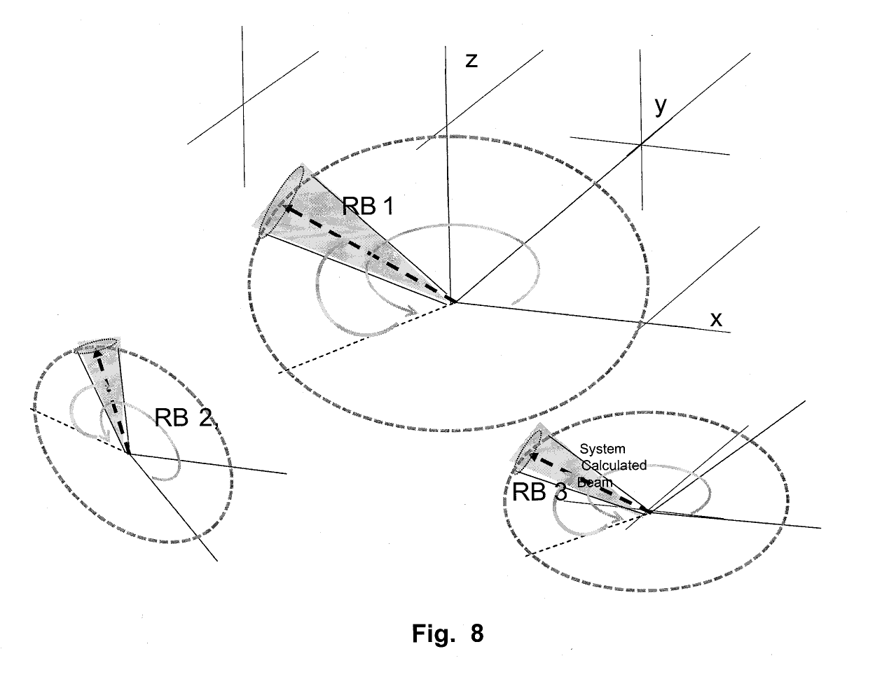

The VB Server 700 can also implement one or more “beam farms”, also called a “beam grids.” A beam farm is essentially a group of reference beams and corresponding searchable data. It can be formed by the VB Server 700 conducting Virtual Beam searches from specified locations in specified directions, as if virtual transceivers were located on for above the Earth's surface at those locations. This approach is illustrated in reference to FIG. 8, which shows a simple beam farm that includes three reference beams, RB1, RB2 and RB3. In one embodiment the VB Server continuously simulates sphere-shaped-beam searches, e.g., according to a defined schedule. The VB Server dynamically can manage its beam farms by adding, deleting, and modifying reference beams.

A reference beam can be, for example, a vector with length L, having its corresponding origination at point P (located at longitude LONG and latitude LAT) and aimed level at an altitude of Z meters (in a simple embodiment, Z=0). It can be seen that spinning, or “scanning”, this reference beam 360 degrees about a vertical (z)-axis would trace the shape of a circle in the x-y plane, with center at point P and radius of L. The circle defines a geographic area, regarding which information on objects and other things of interest is gathered by the server, “geo-tagged” (associated with geographic coordinates) and stored in the search database 43/720. Determining the mathematical functions for such a reference beam is a straightforward process.

If the VB Server is then given the coordinates of a second point Q, it can easily be determined whether point Q is inside the circle, on its periphery, or outside the circle. If the VB Server is given the function of a cone-shaped virtual beam initiated by the user, the area of intersection between the user-initiated virtual beam and the circular reference beam can be determined by the VB Server. In the case of a user-initiated virtual beam that is cone shaped, that area of intersection is an ellipse. This process of determining this is illustrated in FIGS. 5 and 6. Then, the VB Server can perform a join operation in the database 43/720 to make the search results more focused based on, for example, the user's persona, semantics and/or other parameters.

A beam farm can be dense or coarse. For example, a city with many attractions and people might have more reference beams scanning the area and building information on points of interest than a rural area.

A beam farm thus provides a mechanism for constant search (to identify, discover, scan, learn, and mark points, objects or space of interest) of the 3D space and the world around the user. Search results are stored by the VB Server and can be made available and accessible for analysis.

### VIII. User Interface

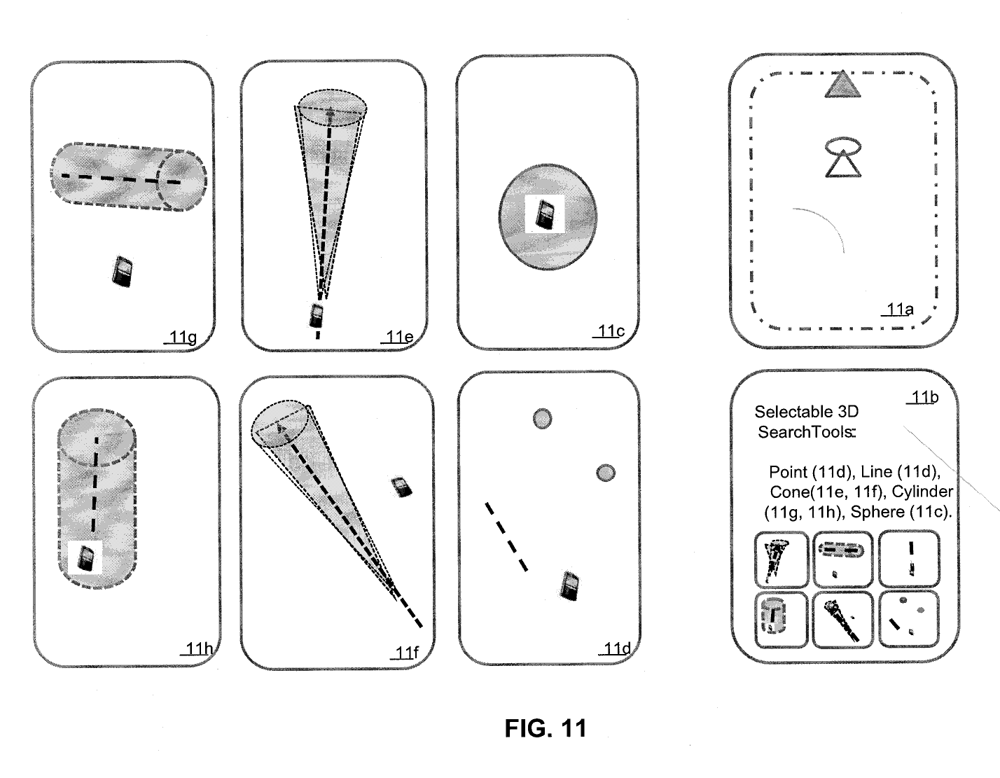

FIG. 11 shows examples of GUI displays that may be generated by the VB Client 400, to enable the user to specify the shape and other parameters of the search (virtual) beam. The user can change position of the virtual transceiver by moving the triangle in display 11a along the dashed line. “Front” position (illustrated) may be the default (similar to holding a TV remote control and pointing at a TV). The user can change beam properties such as shape and depth from a set of icons and/or menu items in display 11b. Alternatively, an API could also provide get, set, and related operations to achieve the same results programmatically without need for user input.

Display 11c in FIG. 11 illustrates a bubble (sphere) shaped beam (a circle in 2-D) surrounding the mobile device (it may be displayed as a circle in 2D on the mobile device, as shown). Display 11d illustrates a beam modeled as a simple vector (dashed line). Displays 11e and 11f illustrate cone-shaped beams, where the beam in display 11e originates from the mobile device, whereas the beam in display 11f originates from a point that is offset from the mobile device. Displays 12g and 12h illustrate cylindrical beams, where the beam in the display 11g originates from the mobile device whereas the beam in screen 11h originates from a point that is offset from the mobile device.

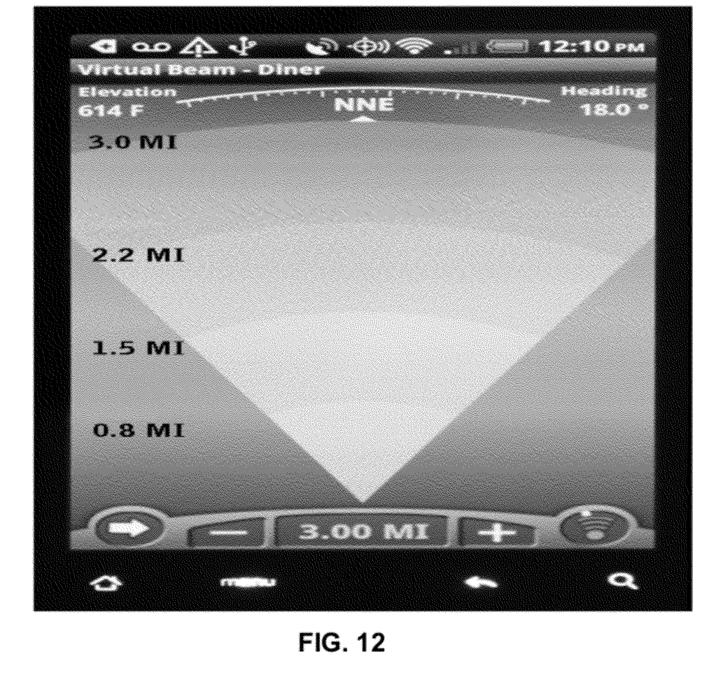

FIGS. 12 through 29 show additional examples of mobile device GUI displays associated with the techniques introduced here. In particular, FIG. 12 shows an example of how the display on the mobile device may indicate to the user that the user has selected a simple cone shaped beam originating from the mobile device. Indications of the length of the cone axis and cone angle range can be displayed, as shown on the left side of the display, and can be increased using touch-screen controls (e.g., “−” and “+” icons at the bottom of the display can change the cone angle). An indicator at the bottom right of the display indicates the direction (in the horizontal plane) in which the most recent search was conducted, so that the user can return to that vector if desired.

FIG. 13 shows various touchscreen controls that can be presented to the user of the mobile device. The user can modify the view (“View” button) or perspective (“Perspective” button), clear the current search results (“Clear” button), initiate a new search (“Search” button), or select a persona from among multiple pre-specified personas (“Personas” button). As indicated in FIG. 14, a persona is a category of information in which the user is interested, such as restaurants (“Diner” persona), tourist information, real estate, shopping, traffic or other commuting information, etc. Persona can be set by the system automatically or it can be selected by the user. This information (which can include, e.g., speed, mood, location) can be used to narrow the scope of the search, normally before the search request is communicated to the server.

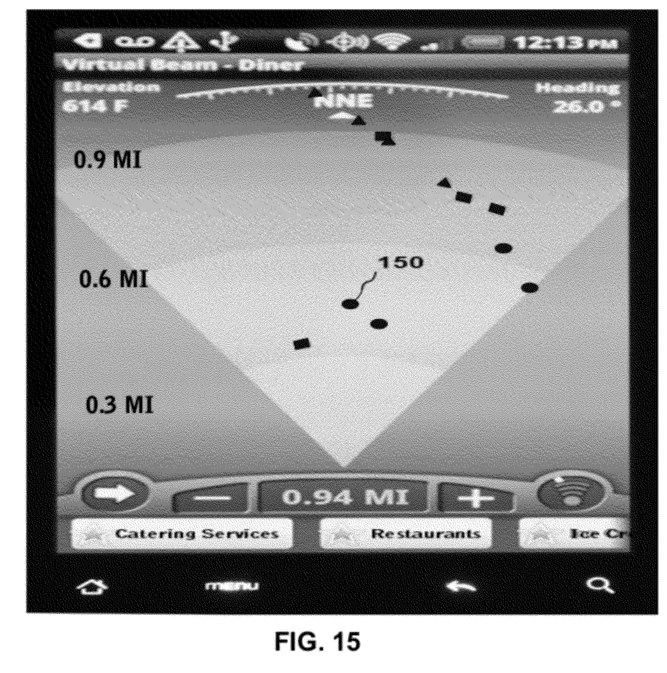

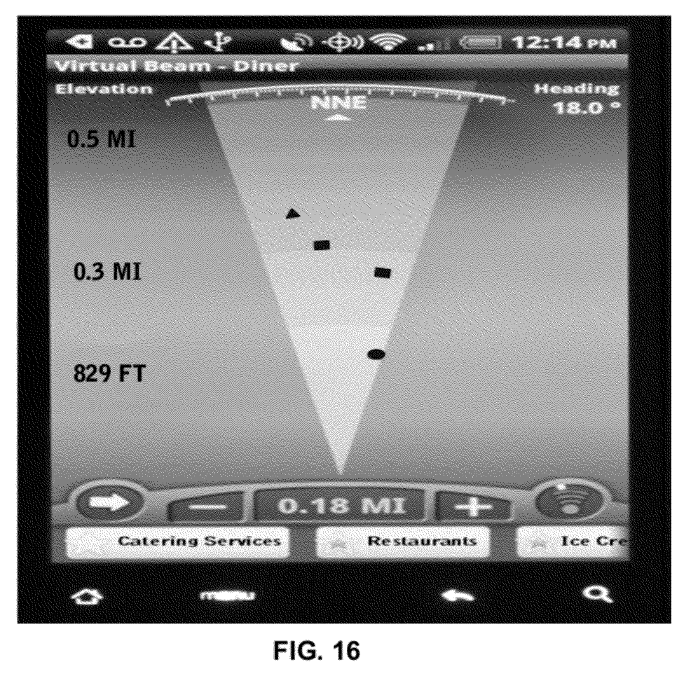

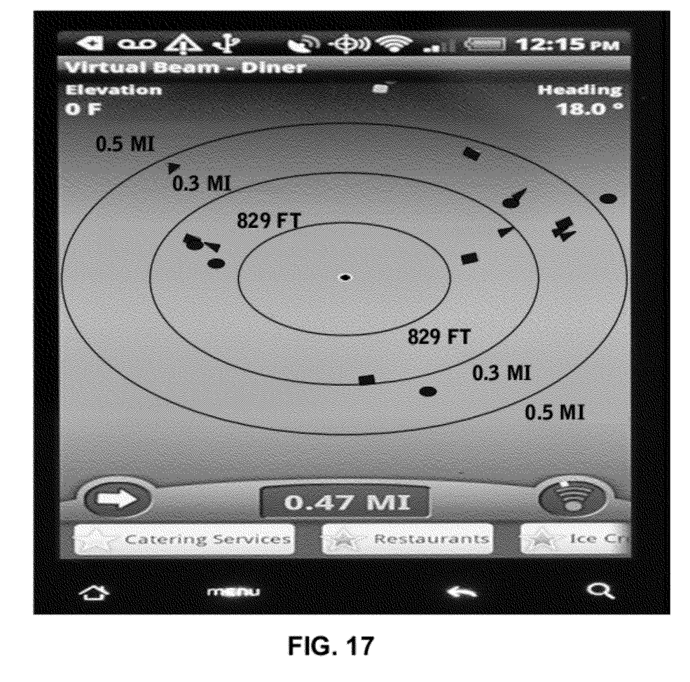

FIG. 15 illustrates a display that indicates search results in the form of various icons 150 that each represent a separate object or other item of interest within the search region. In one embodiment, the user can touch any of the displayed icons to retrieve information about the object/item it represents. FIG. 16, viewed in relation to FIG. 15, illustrates how the user can modify (narrow, in this case) the cone angle of the virtual beam. FIG. 17 illustrates an example of a search result display corresponding to a “bubble” shaped beam, i.e., where the mobile device is located at the center of the circular search area.

FIG. 18 shows an example of a display that allows the user to increase or decrease the range of the virtual beam, e.g., by touching the “−” or “+” icon as appropriate. Touching the boxed area 180 on the screen can also zoom the display results in that area.

### IX. Finding People

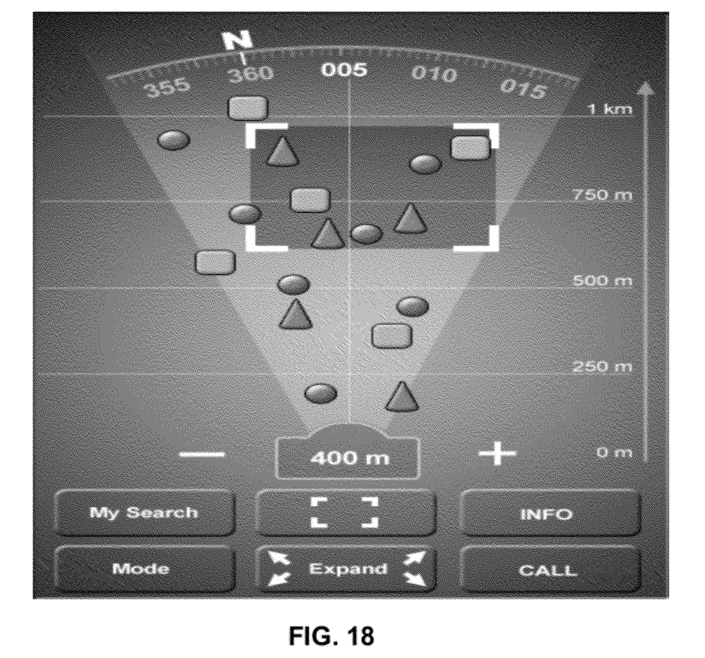

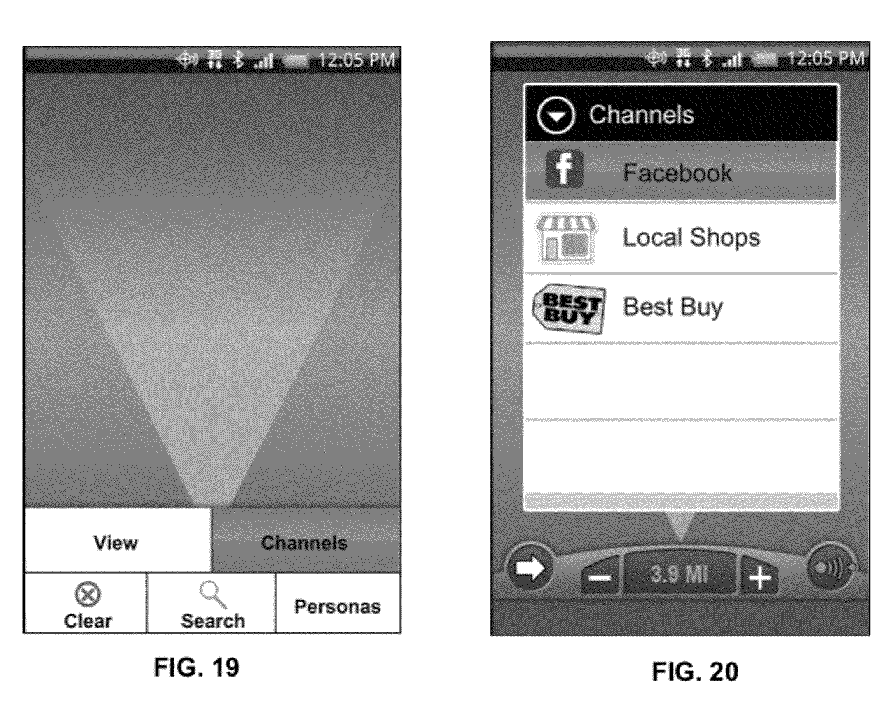

FIGS. 19 through 22 illustrate a sequence of illustrative screen displays that show how the Virtual Beam search technique can also be used to locate people. In certain embodiments, this may be done by locating people who have preregistered with a Virtual Beam service, or who are Facebook friends of the user, or potentially any other people whose identities and locations are in some way made known to the VB Server.

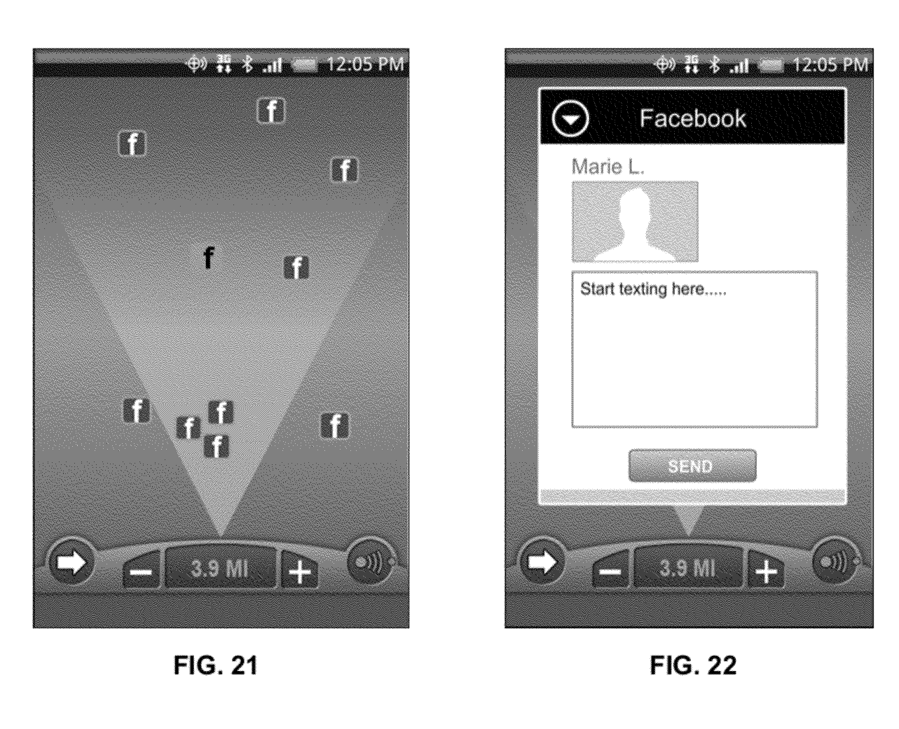

Virtual Beam can display, to the user of the mobile device, visual indications of the locations user's Facebook “friends” and/or other social media contacts (which can be pre-populated on the VB Server), as shown in FIG. 21. By touching the icon that represents a particular contact, the user can display that contact's profile from the appropriate social media Internet site (e.g., Facebook) and, if desired, send that contact a message through the VB Server and the social media Internet site, as shown in FIG. 22. Hence, a Virtual Beam user has the ability to send messages to other users who are in close proximity to him or within a certain geographic area.

### X. Sharing Search Results

The technique introduced here also enables a Virtual Beam user to share his search results with one or more other users, such as friends or other contacts on various social media networks (e.g., Facebook, LinkedIn, MySpace, Xing). For example, a user may initiate a search in San Francisco as a diner (i.e., with “Diner” persona selected). The VB Client can render the search results on the mobile device, while the VB Server has the details on the objects in the result set. Then the user may decide to share the search results with his contacts. So the user therefore submits the results to his Facebook page, for example. The user's Facebook friends and contacts can then see a .gif image, .txt file, list, etc. of the search results. Those contacts can now explore the area, book a restaurant reservation, etc. Hence, one person runs a search but potentially many others can see the results. Virtual Beam can also allow the “friends” and others to interact with search result objects. Any user viewing the search results can be given the ability to interact with the objects discovered through a Virtual Beam search. For example, a user can potentially place an order with a restaurant in response to viewing a menu provided in the search results.

### XI. Other Applications

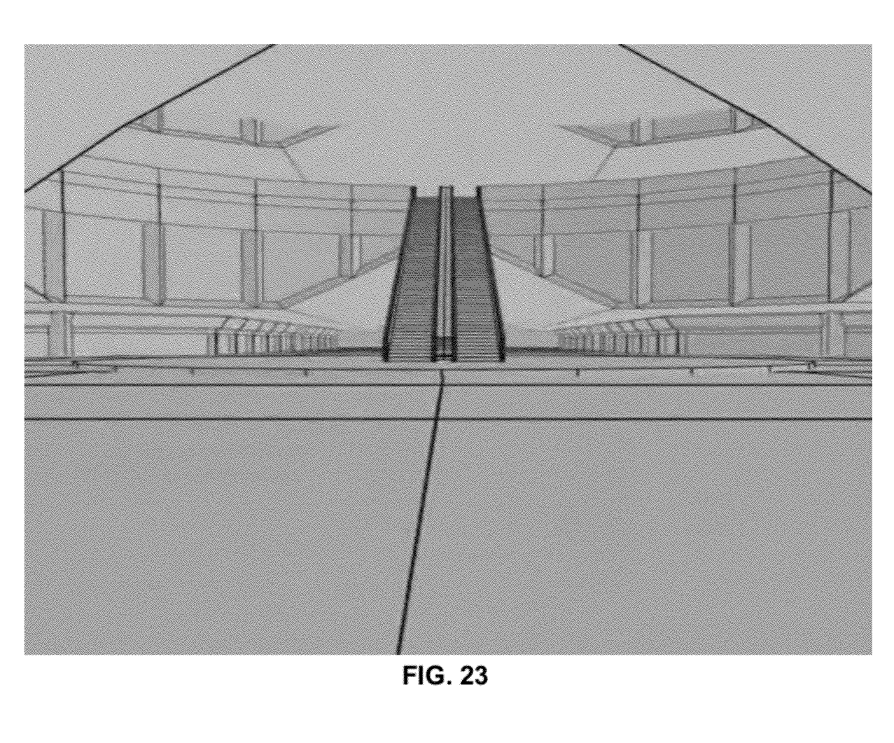

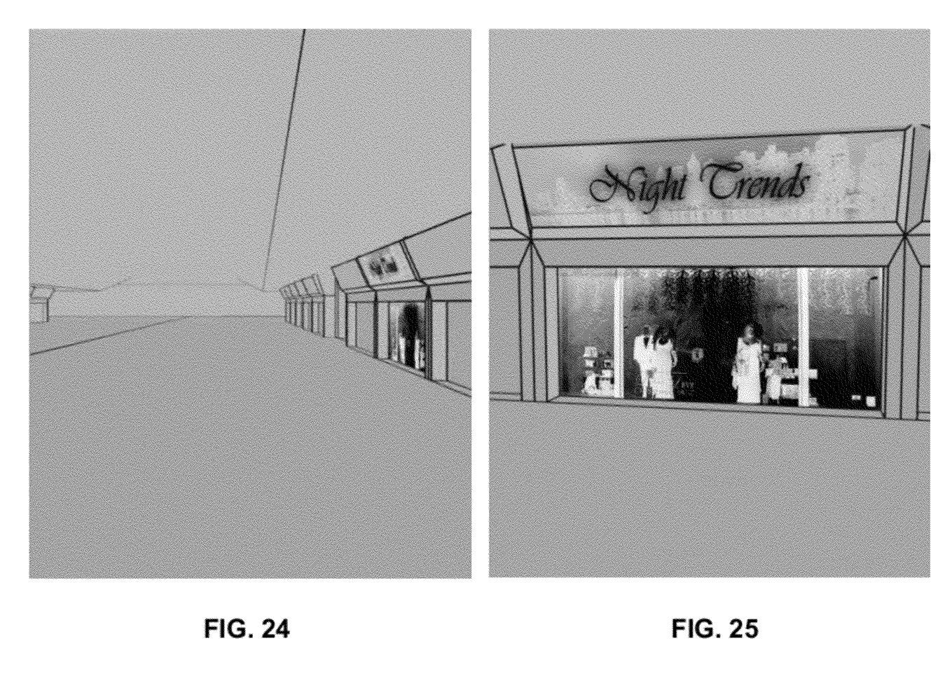

Many different applications and extensions of the technique described above are possible. For example, the Virtual Beam technique can be used to assist mobile device users in navigating and/or locating people, things, etc. within a building or other structure, and to assist users with mobile commerce (m-commerce). Toward that end, a wireframe model of the interior of a building, such as a shopping mall or department store, can be constructed and represented in the form of a database in the server and displayed on a mobile device as illustrated in FIGS. 23 and 24, which show examples of a wireframe model of the inside of a shopping mall. With the cooperation of the property owner, the dimensions of the structure can be captured very precisely in such a model.

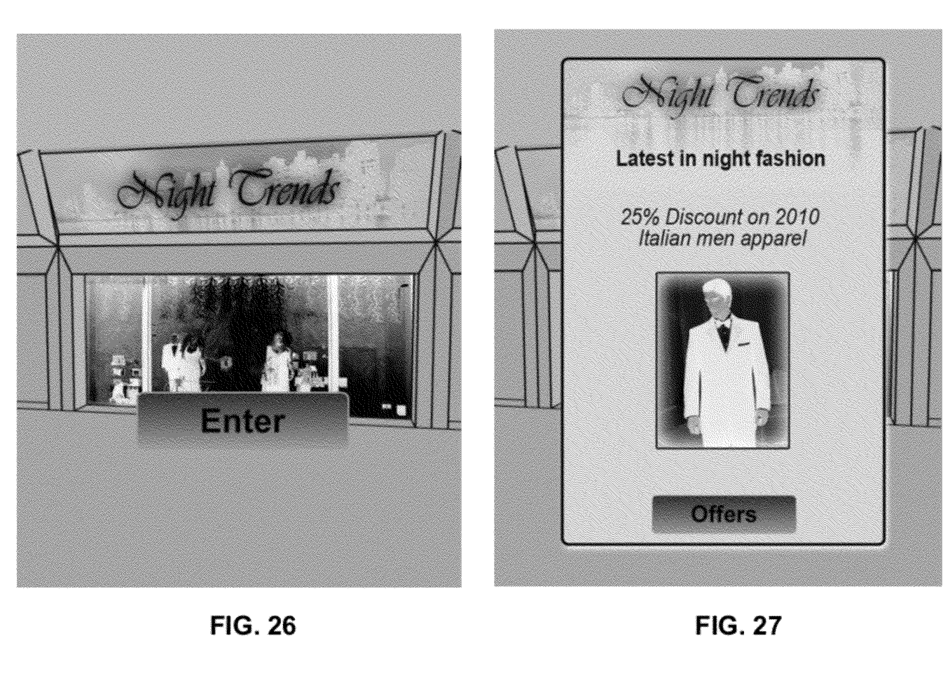

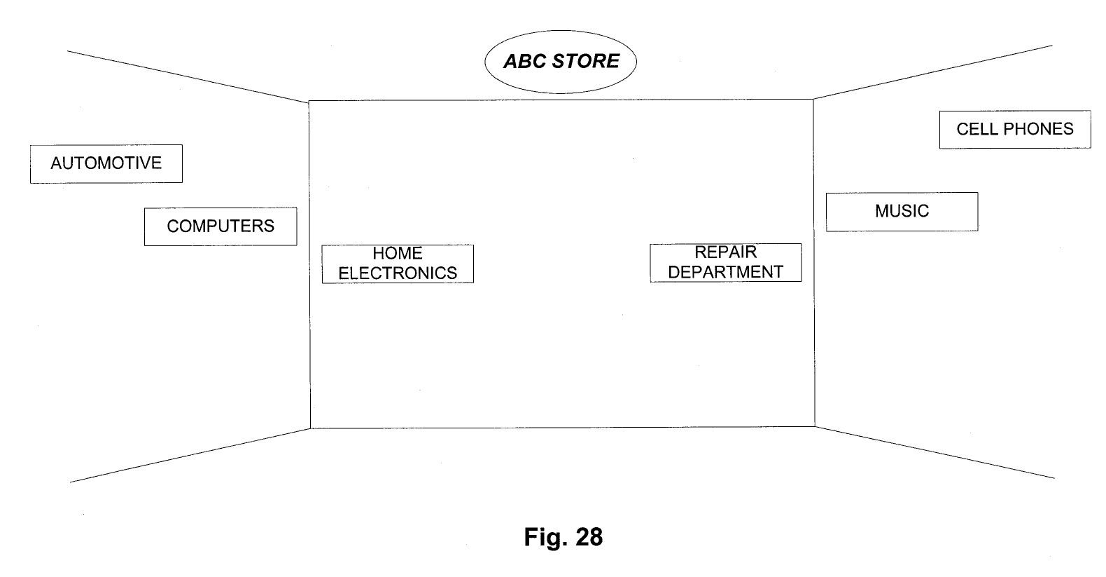

FIGS. 25 through 27 show examples of screen displays that can be rendered on a mobile device, to illustrate how the directional search capabilities of Virtual Beam can allow a user to locate a particular store within a shopping mall by using such a wireframe model. Once a particular storefront is located (FIG. 25), the user can touch an icon or click a button (FIG. 26) to “enter” the store virtually, for example, to view products and/or discounts or sales currently being offered by that store (FIG. 27). The wireframe model data and the content (e.g., special offers and sales) can be pre-populated on the VB Server.

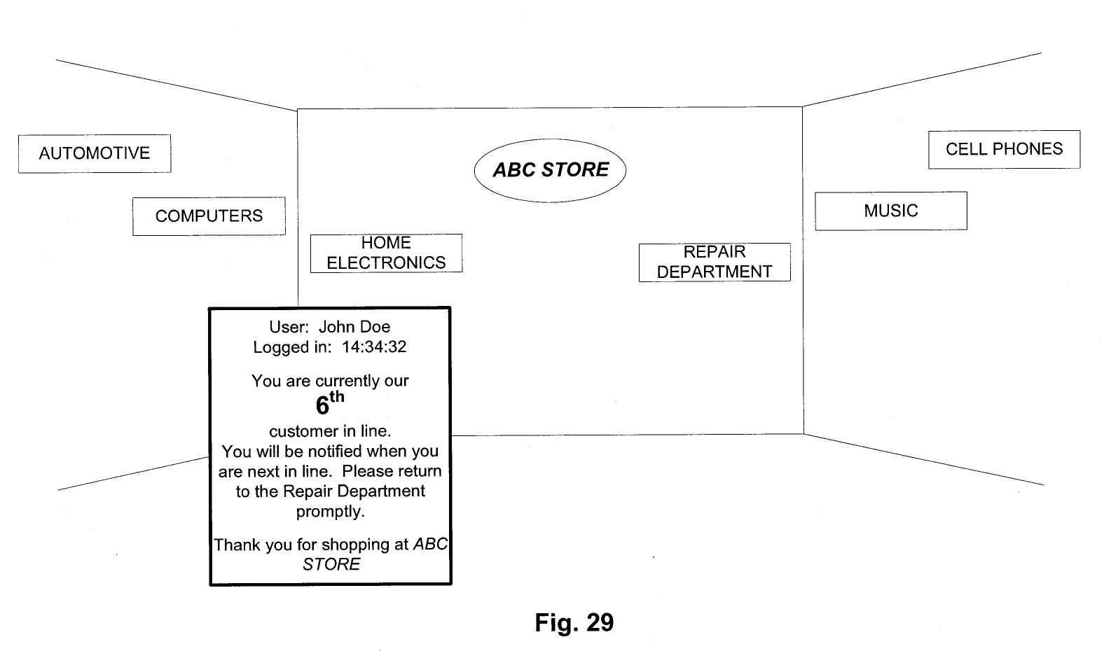

This technique can also be used to allow a user to locate a specific department within a department store, as illustrated in FIG. 29, and to view associated products, sales/discounts, etc. Further, as illustrated in FIG. 29, the user can be provided with the ability to electronically reserve a place in a queue of customers waiting for service, from his mobile phone, and to be continuously updated regarding his current place in line and when it is his turn for service. This capability can be provided via a designated duplex channel provided to the VB Client by the VB Server. Another possible application of this wireframe modeling techniques is to provide personalized museum tours for individual mobile device users.

As indicated above, the Virtual Beam system can provide pre-populated “channels” that users can access, as illustrated in FIGS. 19 and 20. One or more of these channels may be duplex channels, in that they allow the user to interact with a third-party entity represented in the search results. A channel of this sort allows for secure, two-way feedback and can be defined by users and/or content providers. For example, in addition to social media and shopping channels, a restaurant may populate a dining channel with its menu, which can be viewed by a user on his mobile device by accessing a “Dining” channel. When viewing the menu on a mobile device, the user can order a listed item with a gesture or touch to his mobile device, where communication of the order to the restaurant is facilitated by the VB Server. In a similar manner, essentially any type of merchant or service provider can populate a channel with information about the products or services they offer, which can then be purchased or ordered by the user via the channel's duplex capability.

Virtual Beam can also be used to facilitate commerce in a physical retail context. For example, a user can scan an SKU or UPC code on a product with the camera on a mobile device, to obtain information on that product and/or to see in-store offers from that merchant in relation to that product or similar products.

Many other applications can be envisioned by applying or extending the technique introduced here.

The techniques introduced above can be implemented by programmable circuitry programmed/configured by software and/or firmware, or entirely by special-purpose circuitry, or by a combination of such forms. Such special-purpose circuitry (if any) can be in the form of, for example, one or more application-specific integrated circuits (ASICs), programmable logic devices (PLDs), field-programmable gate arrays (FPGAs), etc.

Software or firmware to implement the techniques introduced here may be stored on a machine-readable storage medium and may be executed by one or more general-purpose or special-purpose programmable microprocessors. A “machine-readable medium”, as the term is used herein, includes any mechanism that can store information in a form accessible by a machine (a machine may be, for example, a computer, network device, cellular phone, personal digital assistant (PDA), manufacturing tool, any device with one or more processors, etc.). For example, a machine-accessible medium includes recordable/non-recordable media (e.g., read-only memory (ROM); random access memory (RAM); magnetic disk storage media; optical storage media; flash memory devices; etc.), etc.

The term “logic”, as used herein, means: a) special-purpose hardwired circuitry, such as one or more application-specific integrated circuits (ASICs), programmable logic devices (PLDs), field programmable gate arrays (FPGAs), or other similar device(s); b) programmable circuitry programmed with software and/or firmware, such as one or more programmed general-purpose microprocessors, digital signal processors (DSPs) and/or microcontrollers, or other similar device(s); or c) a combination of the forms mentioned in a) and b).

Note that any and all of the embodiments described above can be combined with each other, except to the extent that it may be stated otherwise above or to the extent that any such embodiments might be mutually exclusive in function and/or structure.

Although the present invention has been described with reference to specific exemplary embodiments, it will be recognized that the invention is not limited to the embodiments described, but can be practiced with modification and alteration within the spirit and scope of the appended claims. Accordingly, the specification and drawings are to be regarded in an illustrative sense rather than a restrictive sense.

What is claimed is:

1. A method comprising:
receiving, at a computer system, data indicative of a pointing vector of a mobile communication device;
defining, by operation of the computer system, a region of physical space as a search region, based on the data indicative of the pointing vector of the mobile communication device;
executing a search, by operation of the computer system, of a database of items tagged with real-world location data, to identify an item associated with the search region; and
sending a result of the search from the computer system to the mobile communication device, the result identifying the item.

2. A method as recited in claim 1, wherein the items tagged with real-world location data in the database represent physical objects.

3. A method as recited in claim 1, wherein the items tagged with real-world location data in the database represent non-physical items.

4. A method as recited in claim 1, wherein the search region is a two-dimensional region.

5. A method as recited in claim 1, wherein the search region is a three-dimensional region.

6. A method as recited in claim 1, wherein executing the search comprises:
identifying, in the database, items that have corresponding physical locations that satisfy a defined spatial relationship criterion relative to the pointing vector.

7. A method as recited in claim 1, wherein defining a region of physical space as the search region comprises mapping the pointing vector of the mobile communication device to a search region of a previously-executed search; and
wherein executing the search comprises identifying physical objects associated with the search region of the previously-executed search.

8. A method as recited in claim 1, wherein said method is performed in response to a search request from the mobile communication device.

9. A method as recited in claim 1, wherein the data indicative of the pointing vector of the mobile communication device comprises data explicitly specifying a vector.

10. A method as recited in claim 1, wherein the data indicative of the pointing vector of the mobile communication device comprises data specifying a position and orientation of the mobile communication device; the method further comprising:
computing, at the computer system, the pointing vector of the mobile communication device, based on the data specifying the position and orientation of the mobile communication device.

11. A method as recited in claim 10, wherein the search region is defined to include the position of the mobile communication device.

12. A method as recited in claim 10, wherein the search region is defined not to include the position of the mobile communication device.

13. A method of operating a mobile communication device, the method comprising:
sending, from the mobile communication device to a remote computer system, data indicative of a pointing vector of the mobile communication device, in association with a search request initiated by a user of the mobile communication device, the data for use by the remote computer system to define a region of physical space as a search region based on the pointing vector;
receiving, from the remote computer system, a search result identifying an item associated with the search region, in response to the search request; and
outputting an indication of the search result to a user of the mobile communication device, the indication of the search result identifying the item.

14. A method as recited in claim 13, wherein the item is a physical object.

15. A method as recited in claim 13, wherein the item is a non-physical object.

16. A method as recited in claim 13, wherein the items in the database represent physical objects.

17. A method as recited in claim 13, wherein the search region is a two-dimensional region.

18. A method as recited in claim 13, wherein the search region is a three-dimensional region.

19. A method as recited in claim 13, wherein executing the search comprises:
identifying, in the database, items that have corresponding real-world locations that satisfy a defined spatial relationship criterion relative to the pointing vector.

20. A method as recited in claim 13, wherein defining a region of physical space as a search region comprises mapping the pointing vector of the mobile communication device to a search region of a previously-executed search; and
wherein executing the search comprises identifying items associated with the search region of the previously-executed search.

21. A method as recited in claim 13, wherein the data indicative of a pointing vector of the mobile communication device comprises data explicitly specifying a vector.

22. A method as recited in claim 13, wherein the data indicative of a pointing vector of the mobile communication device comprises data specifying a position and orientation of the mobile communication device.

23. A processing system comprising:
a network communication device through which to receive data indicative of a pointing vector of a mobile communication device; and
a processor operatively coupled to the network communication device and which, in operation, controls the processing system to perform operations including
defining a region of physical space as a search region, based on the data indicative of the pointing vector of the mobile communication device;
executing a search of a database of items tagged with real-world location data, to identify an item associated with the search region; and
sending a result of the search to the mobile communication device, the result identifying the item.

24. A processing system as recited in claim 23, wherein the items tagged with real-world location data in the database represent physical objects.

25. A processing system as recited in claim 23, wherein the items tagged with real-world location data in the database represent non-physical items.

26. A processing system as recited in claim 23, wherein the search region is a two-dimensional region.

27. A processing system as recited in claim 23, wherein the search region is a three-dimensional region.

28. A processing system as recited in claim 23, wherein executing the search comprises:
identifying, in the database, items that have corresponding physical locations that satisfy a defined spatial relationship criterion relative to the pointing vector.

29. A processing system as recited in claim 23, wherein defining a region of physical space as a search region comprises mapping the pointing vector of the mobile communication device to a search region of a previously-executed search; and
wherein executing the search comprises identifying physical objects associated with the search region of the previously-executed search.

30. A processing system as recited in claim 23, wherein said method is performed in response to a search request from the mobile communication device.

31. A processing system as recited in claim 23, wherein the data indicative of the pointing vector of the mobile communication device comprises data explicitly specifying a vector.

32. A processing system as recited in claim 23, wherein the data indicative of the pointing vector of the mobile communication device comprises data specifying a position and orientation of the mobile communication device; the method further comprising:
computing, at the computer system, the pointing vector of the mobile communication device, based on the data specifying the position and orientation of the mobile communication device.

33. A processing system as recited in claim 32, wherein the search region is defined to include the position of the mobile communication device.

34. A processing system as recited in claim 33, wherein the search region is defined not to include the position of the mobile communication device.

35. A mobile device comprising:
a wireless transceiver;
a location device to determine a location of the mobile device;
an orientation device to determine a physical orientation of the mobile device; and
a processor operatively coupled to the wireless transceiver, the location device and the orientation device, and which, in operation, controls the mobile device to perform operations including
sending, to a remote computer system, data indicative of a pointing vector of the mobile device, in association with a search request initiated by a user of the mobile device, the data for use by the remote computer system to define a region of physical space as a search region based on the pointing vector;
receiving, from the remote computer system, a search result identifying an item associated with the search region, in response to the search request; and
outputting an indication of the search result to a user of the mobile device, the indication of the search result identifying the item.

36. A mobile device as recited in claim 35, wherein the item is a physical object.

37. A mobile device as recited in claim 35, wherein the item is not a physical object.

38. A mobile device as recited in claim 35, wherein the items in the database represent physical objects.

39. A mobile device as recited in claim 35, wherein the search region is a two-dimensional region.

40. A mobile device as recited in claim 35, wherein the search region is a three-dimensional region.

41. A mobile device as recited in claim 35, wherein executing the search comprises:
identifying, in the database, items that have corresponding real-world locations that satisfy a defined spatial relationship criterion relative to the pointing vector.

42. A mobile device as recited in claim 35, wherein defining a region of physical space as a search region comprises mapping the pointing vector of the mobile device to a search region of a previously-executed search; and
wherein executing the search comprises identifying items associated with the search region of the previously-executed search.

43. A mobile device as recited in claim 35, wherein the data indicative of a pointing vector of the mobile device comprises data explicitly specifying a vector.

44. A mobile device as recited in claim 35, wherein the data indicative of a pointing vector of the mobile device comprises data specifying a position and orientation of the mobile device.

45. A non-transitory machine-readable storage medium storing instructions which, when executed in a mobile device, cause the mobile device to perform a process comprising:
sending, to a remote computer system, data indicative of a pointing vector of the mobile device, in association with a search request initiated by a user of the mobile device, the data for use by the remote computer system to define a region of physical space as a search region based on the pointing vector;
receiving, from the remote computer system, a search result identifying an item associated with the search region, in response to the search request; and
outputting an indication of the search result to a user of the mobile device, the indication of the search result identifying the item.
